(19) United States
(12) Patent Application Publication
(10) Pub. No.: US 2025/0211784 A1
(43) Pub. Date: Jun. 26, 2025

(54) V-PCC BASED DYNAMIC TEXTURED MESH CODING WITHOUT OCCUPANCY MAPS

(71) Applicant: INTERDIGITAL CE PATENT HOLDINGS, SAS, Paris (FR)

(72) Inventors: Julien RICARD, Plouër-sur-Rance (FR); Jean-Eudes MARVIE, Betton (FR); Olivier MOCQUARD, Rennes (FR); Maja KRIVOKUCA, Rennes (FR)

(21) Appl. No.: 18/847,287

(22) PCT Filed: Mar. 2, 2023
(86) PCT No.: PCT/EP2023/055282

§ 371 Date: Sep. 16, 2024

(30) Foreign Application Priority Data
Mar. 17, 2022 (EP) 22305317.4
Jun. 7, 2022 (EP) 22305826.4

(51) Int. Cl. H04N 19/597; G06T 17/20; H04N 19/184; H04N 19/70

(52) U.S. Cl. CPC H04N 19/597; G06T 17/205; H04N 19/184; H04N 19/70

(57) ABSTRACT

An approach extends a Video-Point Cloud Compression codec approach to store mesh information and provide a good efficiency and a good objective and subjective quality. To reduce the quantity of data that needs to be transmitted, the approach removes occupancy maps that are used to know which parts of the patches are occupied. These occupancy maps create a lot of artifacts on the borders of the patches due to the occupancy map sub-resolution used to transmit the occupancy information. Instead, the approach transmits the 3-Dimensional borders of the patches (list of the 3D points constituting the borders of the patches) and uses this information to identify which parts of the 2D patches are occupied and connect the 3D reconstructed patches according to the real 3D borders of the patches.

### TECHNICAL FIELD

The technical field of the disclosure is video compression, more specifically video coding of a 3D mesh consisting of points in a 3D space with associated attributes (e.g. connectivity, texture associated with the mesh, 2D coordinates of points in the texture image).

### BACKGROUND

One of the approaches (MPEG 3DG/PCC's Test Model for Category 2, called TMC2) used in the state of the art to achieve good compression efficiency when coding point clouds consists of projecting multiple geometry and texture/attribute information onto the same position (pixel) of a 2D image; i.e., coding several layers of information per input point cloud. Typically, two layers are considered.

### SUMMARY

At least one of the present embodiments generally relates to a method or an apparatus in the context of the compression of images and videos of a 3D mesh with associated attributes.

According to a first aspect, there is provided a method. The method comprises steps for decoding one or more video bitstreams to obtain depth maps and attribute maps; further decoding a bitstream containing lists of border points to obtain segments of border points; generating a plurality of lists of adjacent patches based on syntax information; obtaining segments of border points of patches from said border points coded in said bitstream and from said lists of adjacent patches; generating occupancy maps of said patches using segments of border points of patches; building meshes of said patches based on occupancy, depth, and attribute maps; and, filling of inter-patch spaces between reconstructed patches and said segments of border points to obtain reconstructed models.

According to a second aspect, there is provided a method. The method comprises steps for correcting geometry and topology of a scaled three-dimensional mesh model; grouping triangles of the mesh into connected components; refining said connected components; extracting patch border segments of patches; creating occupancy maps of said patches from said patch border segments; rasterizing meshes of the connected component of said patches to create depth maps of the patches and depth video frames; reconstructing three-dimensional meshes of said patches from depth maps and said occupancy maps; filling inter-patch spaces based on said patch border segments and border edges of the reconstructed meshes of the patches; extracting all vertices of the mesh based on said reconstructed meshes to create a reconstructed point cloud; coloring the points of the reconstructed point cloud, and, using the colored reconstructed point cloud to create attribute video frames.

According to another aspect, there is provided an apparatus. The apparatus comprises a processor. The processor can be configured to implement the general aspects by executing any of the described methods.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates a V-PCC encoder.

FIG. 2 illustrates a V-PCC decoder.

FIG. 3 illustrates an example of border segments of patches.

FIG. 4 illustrates an example of 2-dimensional triangularization of borders of patches.

FIG. 5 illustrates an example of inter-patch space filling with (a) reconstructed meshes and (b) triangulated mesh.

FIG. 6 illustrates an example of another V-PCC decoder.

FIG. 7 illustrates an example of free-viewpoint video.

FIG. 8 illustrates examples of reconstructed 3-dimensional animated mesh sequences.

FIG. 9 illustrates one example of a reconstructed animated textured mesh (top) wireframe view and (b) associated texture atlas.

FIG. 10 illustrates an example of a mesh encoding proposal extending V-PCC.

FIG. 11 illustrates an example of mesh decoding proposal extending V-PCC.

FIG. 12 illustrates an example of a flowchart for encoding.

FIG. 13 illustrates an example of a flowchart for decoding.

FIG. 14 illustrates a V-PCC encoder architecture.

FIG. 15 illustrates a V-PCC decoder architecture.

FIG. 16 illustrates a modified V-PCC encoder.

FIG. 17 illustrates a modified V-PCC decoder.

FIG. 18 illustrates example of border segments of patches.

FIG. 19 illustrates an example of border segments extraction (a) source model (b) oriented edges between patches (c) concatenated edges (d) border segments build by concatenation of edges.

FIG. 20 illustrates an example of a list of adjacent patches.

FIG. 21 illustrates an example of building patch occupancy map.

FIG. 22 illustrates an example of intersection points on border segments.

FIG. 23 illustrates an example of occupancy map and intersection points computed on 3-dimensional patch.

FIG. 24 illustrates an example of points of an occupancy map used to reconstruct mesh squares.

FIG. 25 illustrates an example of intersection points that are used to build mesh of a square.

FIG. 26 illustrates an example of the Douglas-Peucker algorithm.

FIG. 27 illustrates an example of border segments simplification with (a) original (b) threshold=1 (c) threshold=2 and (d) threshold=4.

FIG. 28 illustrates an example of aliasing: (a) original (b) reconstructed mesh.

FIG. 29 illustrates an example of depth map projection in 2D of an edge of a mesh.

FIG. 30 illustrates another example of depth map projection in 2D of an edge of a mesh.

FIG. 31 illustrates an example of a reconstructed model with scaling of depth maps: (a) original (b) reconstructed mesh using scaled depth.

FIG. 32 illustrates V3CN-PCC mesh encoding processes.

FIG. 33 illustrates an example of border ambiguities due to degenerate triangles.

FIG. 34 illustrates V3DN-PCC mesh decoding processes.

FIG. 35 illustrates one embodiment of a method for performing the described aspects.

FIG. 36 illustrates another embodiment of a method for performing the described aspects.

FIG. 37 illustrates a processor-based system for implementing the described aspects.

FIG. 38 illustrates another processor-based system for implementing the described embodiments.

FIG. 39 illustrates examples of reconstructed meshes with one occupied point.

FIG. 40 illustrates examples of reconstructed meshes with two occupied points.

FIG. 41 illustrates examples of reconstruction process if two occupied points are not adjacent.

FIG. 42 illustrates examples of reconstructed meshes with three occupied points.

FIG. 43 illustrates examples of reconstructed meshes with four occupied points.

FIG. 44 illustrates an example of reconstructed mesh patches.

FIG. 45 illustrates V3CN-PCC mesh encoding processes.

FIG. 46 illustrates an example of updated V3CN-PCC mesh encoding processes.

FIG. 47 illustrates V3CN-PCC mesh decoding processes.

FIG. 48 illustrates updated V3CN-PCC mesh decoding processes.

### DETAILED DESCRIPTION

One or more embodiments rest upon concepts introduced in other works under the name “mesh coding using V-PCC” and proposed as EE2.6 of the PCC Ad hoc Group.

The following sections briefly introduce background concepts on:
Point cloud codec: V-PCC
Mesh formats: simple ones

### V-PCC Overview—Point Cloud Compression (No Mesh)

One of the approaches (MPEG 3DG/PCC's Test Model for Category 2, called TMC2) used in the state of the art to achieve good compression efficiency when coding point clouds consists of projecting multiple geometry and texture/attribute information onto the same position (pixel) of a 2D image; i.e., coding several layers of information per input point cloud. Typically, two layers are considered. This means that several 2D geometry and/or 2D texture/attribute images are generated per input point cloud. In the case of TMC2, two depth (for geometry) and color (for texture a.k.a. attribute) images are coded per input point cloud.

One embodiment proposes to extend the V-PCC (MPEG-I part 5) codec of the MPEG 3D Graphics (3DG) Ad hoc Group on Point Cloud Compression to enable to address meshes compression and to enable to address dynamic textured meshes compression. It supplements an idea that proposed a new coding scheme to code 3D meshes without occupancy map and proposes new methods to build the occupancy maps of the patches, to reconstruct the patches and to fill the inter-patch spaces.

The described embodiments propose a novel approach to build the occupancy maps of the patches, to reconstruct the patches and to fill the inter-patch space based on the border segments of the patches, defining the lists of 3D points of the borders of the patches, and on the patch information (patch parameters, depth map, attribute map).

The methods to build the occupancy map and to fill the inter-patch spaces triangulate the areas defined:
By the border segments of the patches for the occupancy maps, and;
   By the border segments of the patches and of the border edges of the reconstructed patches for the inter-patch filling.

These processes are complex and required to extract the border edges from the reconstructed patches. To make these processes more efficient and allow a parallel reconstruction of the patches, these processes have been updated to allow in only one pass the reconstruction of the patches and the filling of the border of the patches.

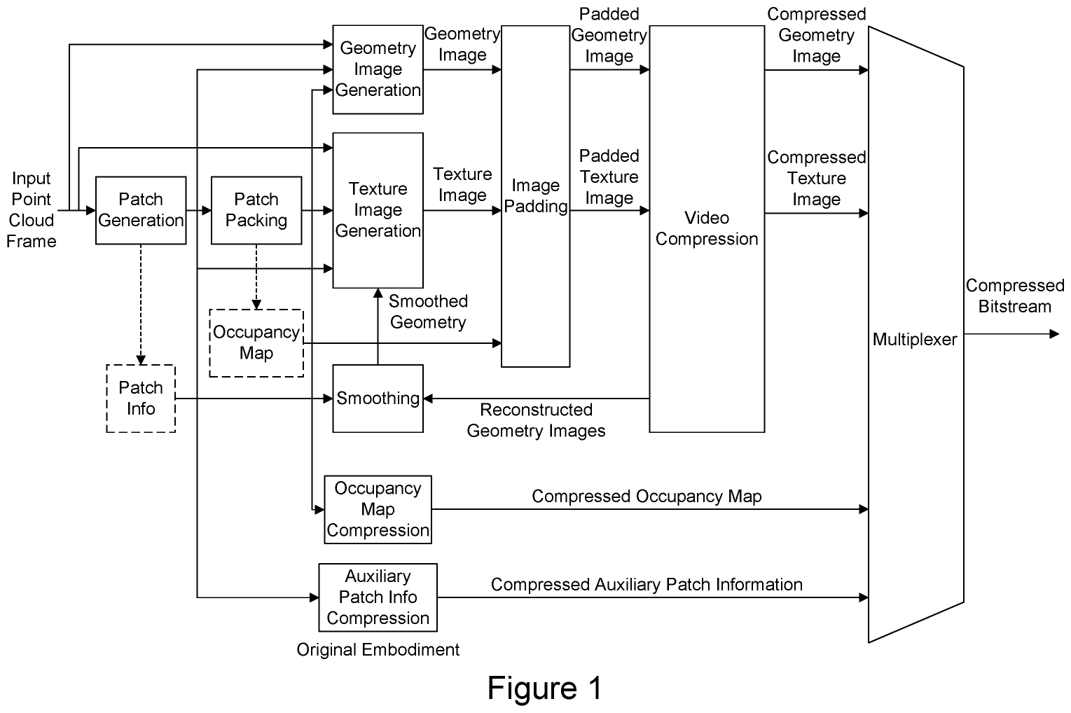

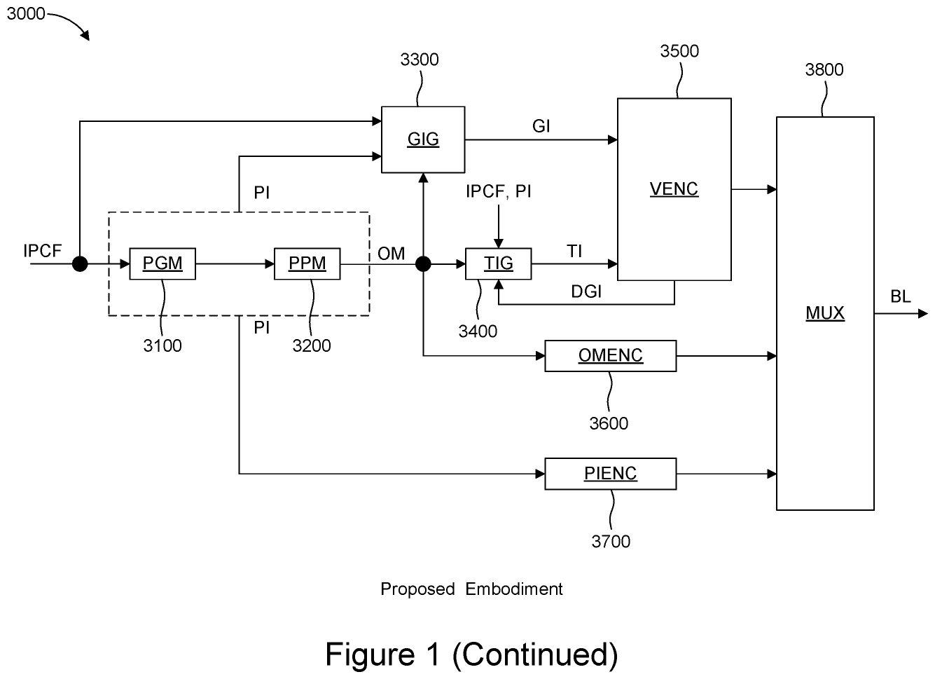

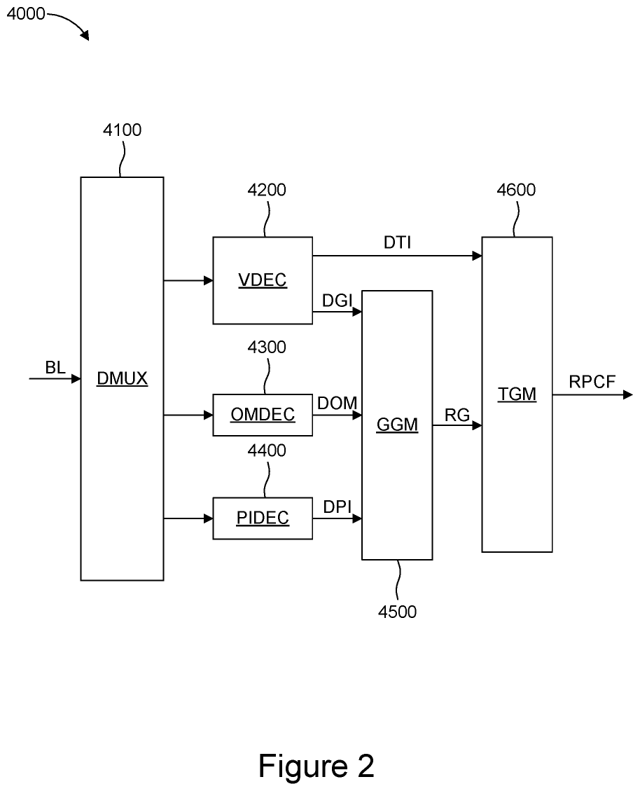

One embodiment relates to the V-PCC codec, whose structure is shown in FIG. 1 (encoder and proposed embodiment) & FIG. 2 (decoder):

### Volumetric Videos

“Interest in free-viewpoint video (FVV) has soared with recent advances in both capture technology and consumer virtual/augmented reality hardware, e.g., Microsoft HoloLens. As real-time view tracking becomes more accurate and pervasive, a new class of immersive viewing experiences becomes possible on a broad scale, demanding similarly immersive content.” Cite from Microsoft (Collet, et al., 2015).

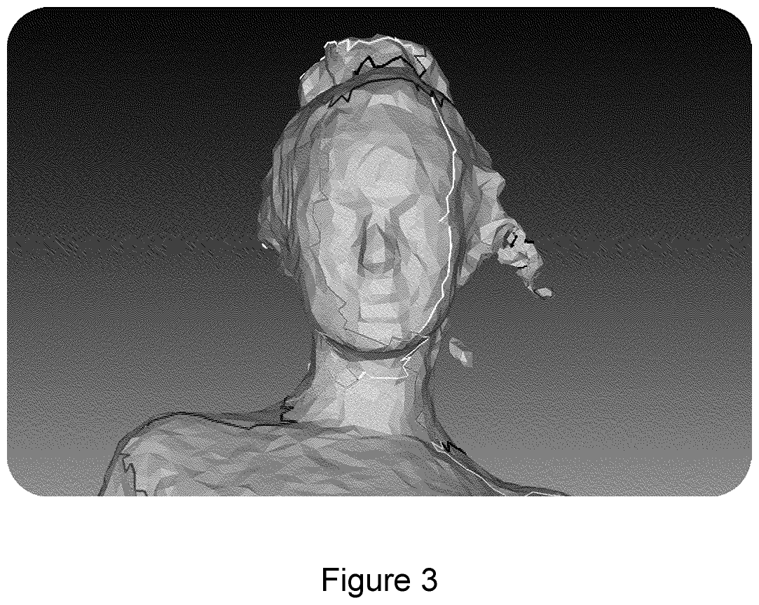

Patches are represented by sets of parameters including the lists of border segments defining the 3D points of the borders of the patches. FIG. 3 shows an example of the border segments on a mesh.

The animated sequence that is captured can then be re-played from any virtual viewpoint with six degrees of freedom (6 dof). In order to provide such capabilities, image/video, point cloud, and textured mesh approaches exist.

The Image/Video-based approach will store a set of video streams plus additional metadata and perform a warping or any other reprojection to produce the image from the virtual viewpoint at playback. This solution requires heavy bandwidth and introduces many artifacts.

The point cloud approach will reconstruct an animated 3D point cloud from the set of input animated images, thus leading to a more compact 3D model representation. The animated point cloud can then be projected on the planes of a volume wrapping the animated point cloud, and the projected points (a.k.a. patches) encoded into a set of 2D coded video streams (e.g. using HEVC, AVC, VVC, . . . ) for its delivery. This is the solution developed in the MPEG V-PCC (ISO/IEC JTC1/SC29 WG11, w19332, V-PCC codec description, April 2020) standard, which leads to very good results. However, the nature of the model is very limited in terms of spatial resolution, and some artifacts can appear, such as holes on the surface for closeup views.

The border segments of a patch are used to:
build the occupancy map of the patch, representing the area really covered by the patch;
extend the 3D reconstructed patch until the real of the border segments, real 3D position of the patches set by the encoder.

These processes will be updated by the embodiments described in the rest of this document, are:
Occupancy map reconstruction
Reconstruction of the 3D meshes of the patches
Filling of the inter-patch spaces

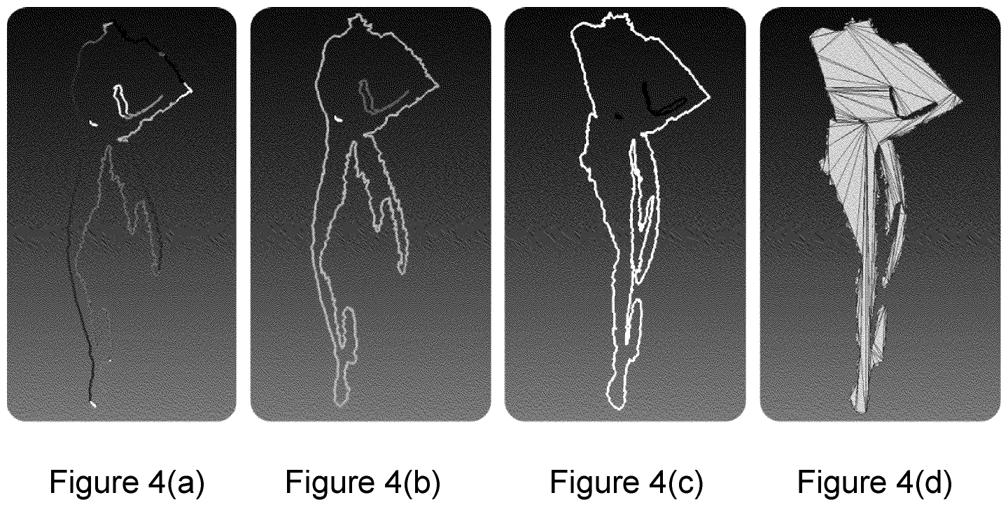

These two processes were carried out by triangulating the 2D polygons extracted from the 3D border segments and the borders of the reconstructed patches in our earlier approach. FIG. 4 shows an example of the building of the occupancy map of one patch by triangulation of the 2D polygons. The obtained mesh is rasterized into a 2D map to build the 2D occupancy map.

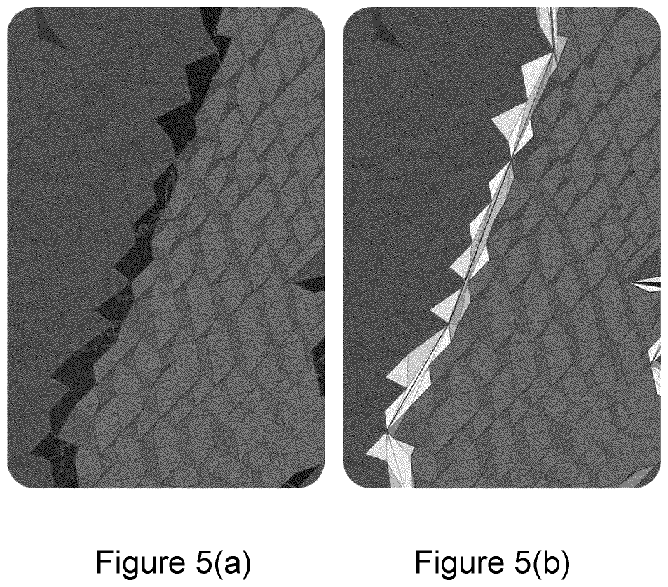

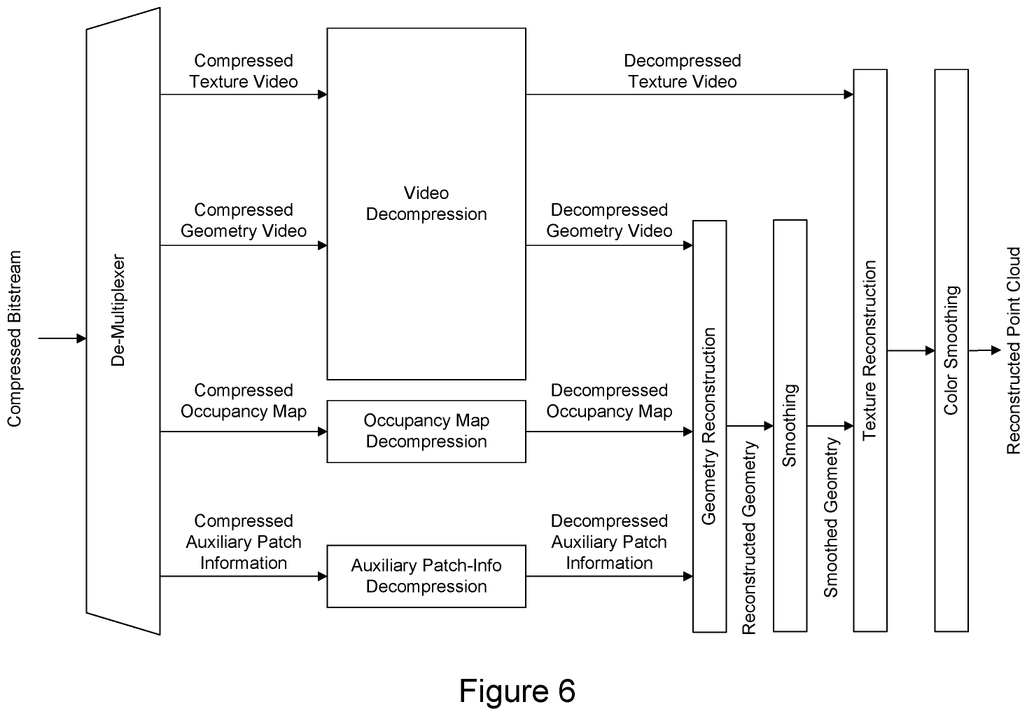

With the same triangulation process used to create the occupancy maps, the inter-patch spaces are filled by triangulating the 2D polygons built based on the border segments and on the border edges of the reconstructed patches. This process result is shown in FIG. 5.

An updated embodiment describing the building of the occupancy map is described.

An improved patch reconstruction process is described in a later section.

The process for the filling of the inter-patch spaces presented in an earlier approach has been removed because this process is now directly carried out during the patch reconstruction process.

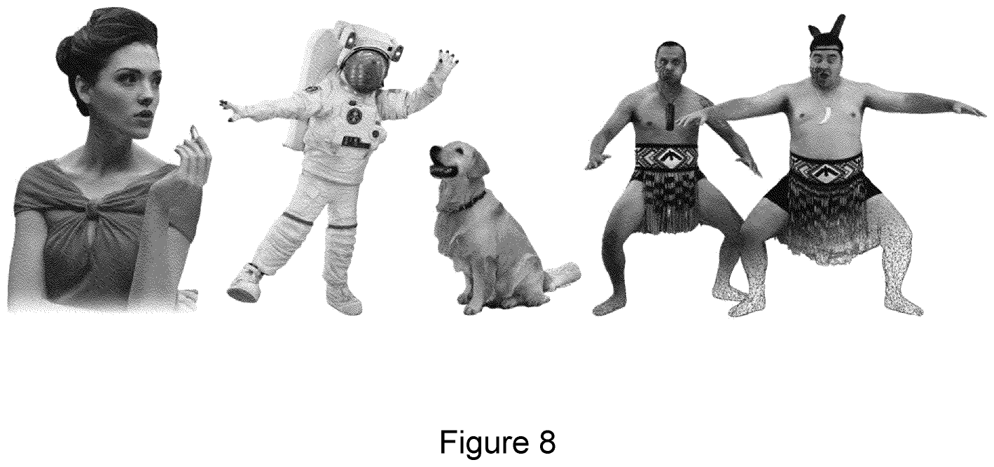

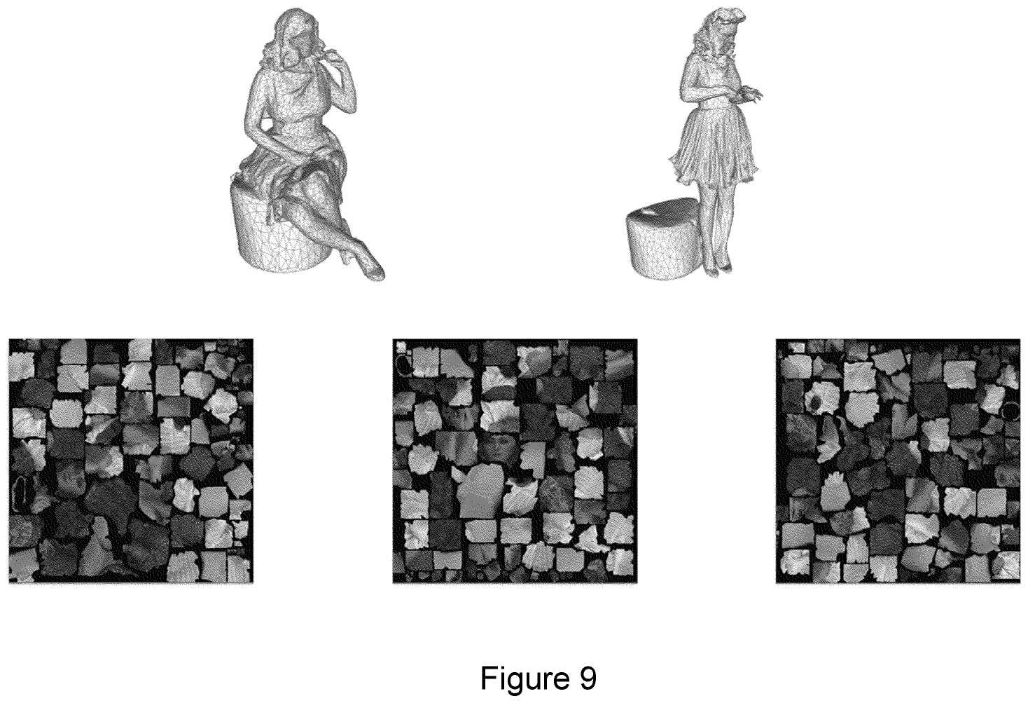

The textured mesh approach will reconstruct an animated textured mesh (see FIG. 8) from the set of input animated images (Collet, et al., 2015) (Carranza, Theobalt, Magnor, & Seidel, 2003). This kind of reconstruction usually passes through an intermediate representation as voxels or point clouds. FIG. 9 illustrates the kind of quality that can be obtained by such a reconstructed mesh. The advantage of meshes is that geometry definition can be quite low, and a photometry texture atlas can be encoded in a standard video stream (see FIG. 9, bottom). Point cloud solutions require “complex” and “lossy” implicit or explicit projections (ISO/IEC JTC1/SC29 WG11, w19332, V-PCC codec description, April 2020) to obtain planar representations compatible with video-based encoding approaches. In counterpart, textured mesh encoding relies on texture coordinates (“uv”s) to perform a mapping of the texture image to triangles of the mesh. Where video-based encoding (e.g., with HEVC) of the texture atlas can lead to very high compression rates with minimum loss, we will see that the encoding of the remaining part describing the topology (the list of faces) and vertex attributes (position, uvs, normals, etc.) using video encoding remains challenging. It is also to be noted that the relative size of the raw image atlas with respect to the raw geometry (topology plus attributes) is variable according to the reconstruction parameters and the targeted applications. However, the geometry is generally smaller in raw size than the photometry (the texture atlas). Nevertheless, efficient encoding of the geometry is still of interest to reduce the global payload. In addition, using video encoders such as HEVC to encode the geometry would lead to a pure video-based compression compatible to some extent with most existing HEVC implementations, including hardware ones.

Textured mesh and point cloud solutions are both relevant, and even image/video solutions under some specific conditions. The modality (mesh or point cloud) is usually selected by the author according to the nature of the model. Sparse elements such as hairs or foliage will get better rendering using point clouds. Surfaces such as skin and clothes will get better rendering using meshes. Both solutions are thus good to optimize. Also note that these solutions can be combined to represent different parts of a model.

### Problem to be Solved

One or more embodiments propose a novel approach to leverage V-PCC coder (that is projection based) to encode dynamic textured meshes. We propose a complete chain to project meshes into patches that are encoded using V-PCC video-based schemes. We also present a solution to prevent the need for encoding occupancy maps as requested in standard V-PCC chains. Instead, we propose edge contours encoding. Some additional solutions such as fast implicit re-meshing which prevents the encoding of topology as well as some filtering methods to enhance reconstructed meshes are also presented.

### Previous Works

In an Exploratory Experiment (EE) tracked in V-PCC, a solution was proposed to combine the use of V-PCC with the TFAN codec as a vertex connectivity codec.

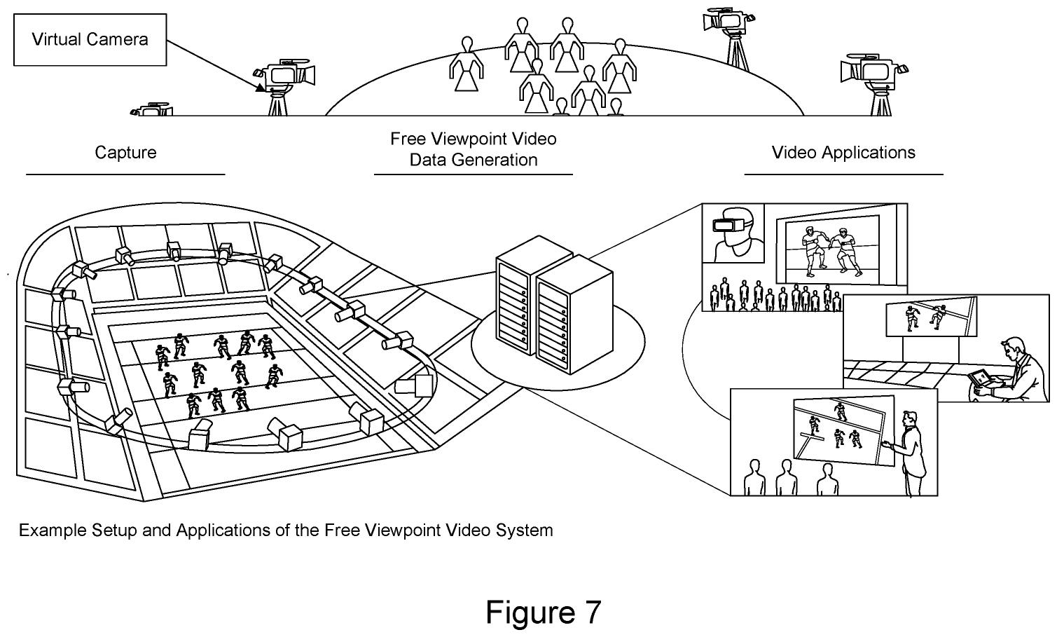

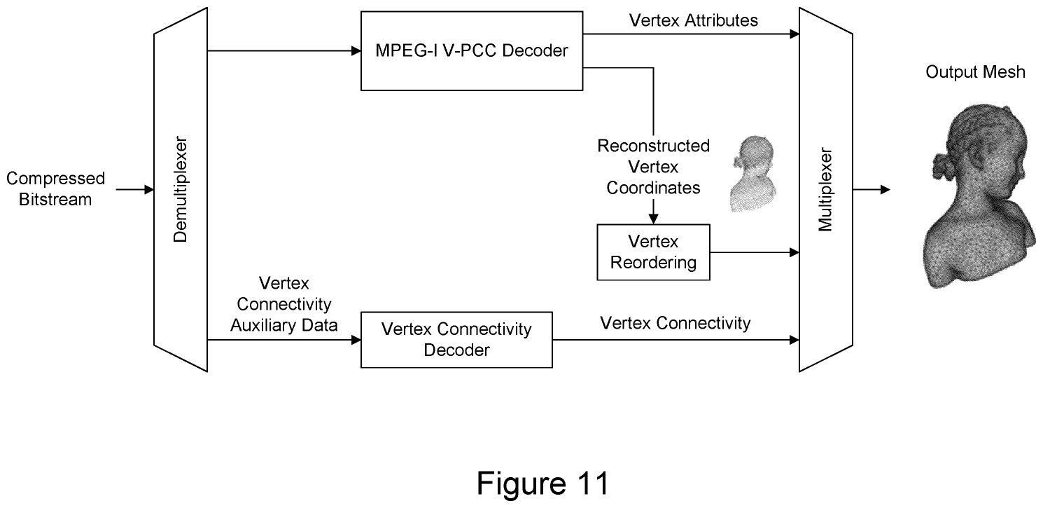

Encoding and decoding architectures of such a proposition are respectively depicted in FIG. 7 and FIG. 11.

Basically, at the encoder side, an input mesh is decomposed (demultiplexed) into two sets:
vertex coordinates and vertex attributes, which are fed into a V-PCC encoder
vertex connectivity, which is encoded by a TFAN encoder

As the TFAN encoder generates data whose order is different from that of the input mesh, a reordering process must be applied with respect to the V-PCC output ordering.

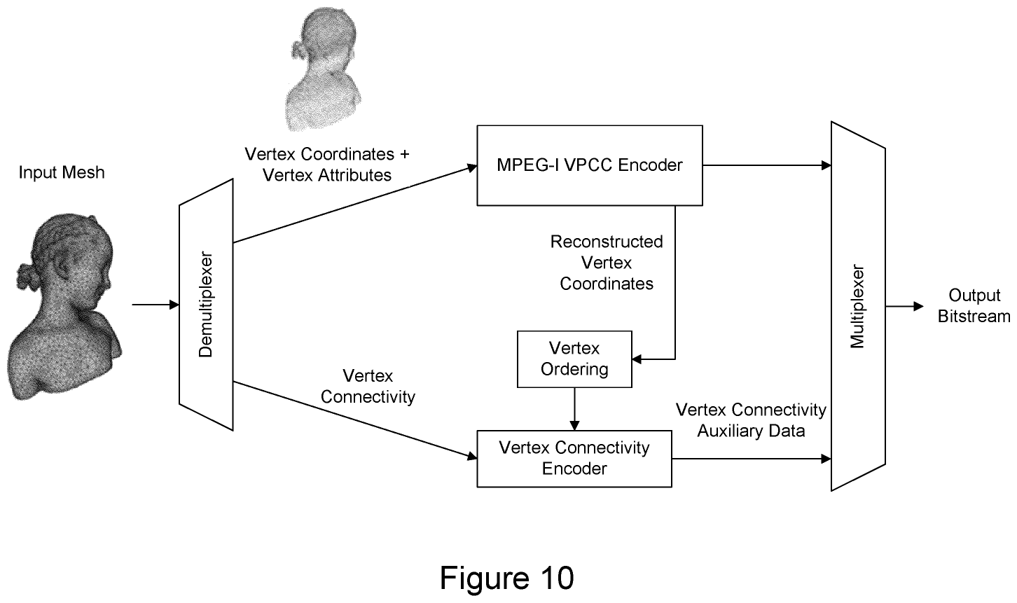

In a first version, it was proposed to reorder on both sides and the transmission of such a reordering table (FIG. 10 and FIG. 11). Then, a second version proposed to reorder the input point cloud of V-PCC with respect to the output TFAN ordering so that no reordering information needs to be transmitted. Then, geometry and attributes are packed into V-PCC RAW patches according to the traversal order of TFAN connectivity. As defined in V3CN-PCC specification (w19579_ISO_IEC_FDIS_23090-5, section H.11.4 Reconstruction of RAW patches), the RAW patches code the geometry coordinates and the attribute values of the 3D RAW points directly in the three components of the geometry frames and of the attribute frames.

The resulting encodings are multiplexed into a so-called extended V-PCC bitstream.

It should be noted that when meshes are considered sparse (and the attributes are contained separately in an image file), this approach proposes a pre-processing: downscaling, transforming the texture images to vertex colors, and then voxelizing them to 10 bits prior to cleaning non-manifold and degenerative faces resulting from the voxelization procedure.

At the decoder side, dual operations of the encoder are performed so that the mesh is reconstructed.

Although this proposal leverages and combines two existing codecs, the following disadvantages are pointed out:
Need for two codecs with interfacing modifications to consider point cloud reordering
Said reordering may induce latency on the encoder side (depending on the ordering of the vertices, one may need to wait for the whole mesh to be processed for reordering)
One of the two codecs (TFAN) is 10+ years old and it has reportedly never been implemented nor considered by the industry
Invasive modifications of the syntax of the V-PCC bitstream are needed in order to integrate the TFAN data
There may be texture loss as attributes are associated to each point (vertex)—texture may be denser than the vertex/point density.
This solution is only valid for lossless coding.

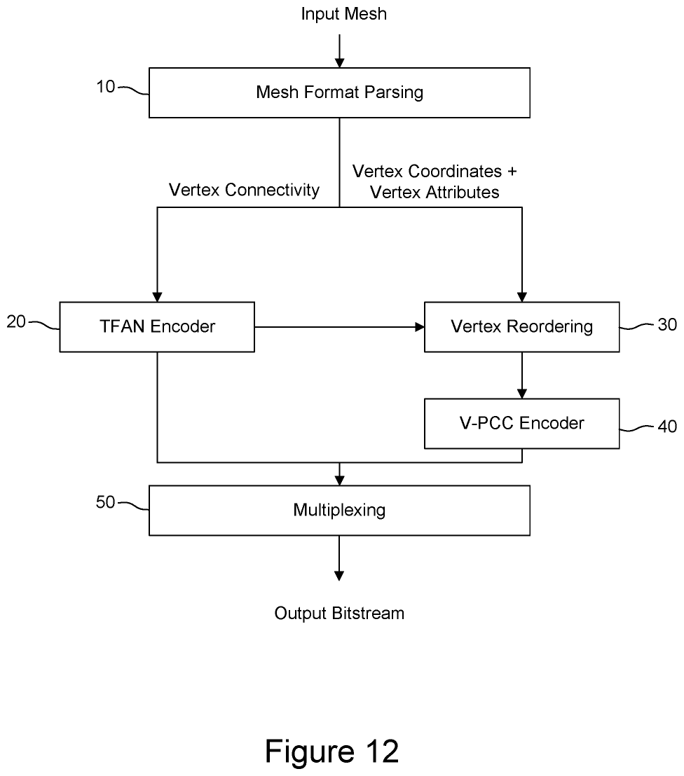

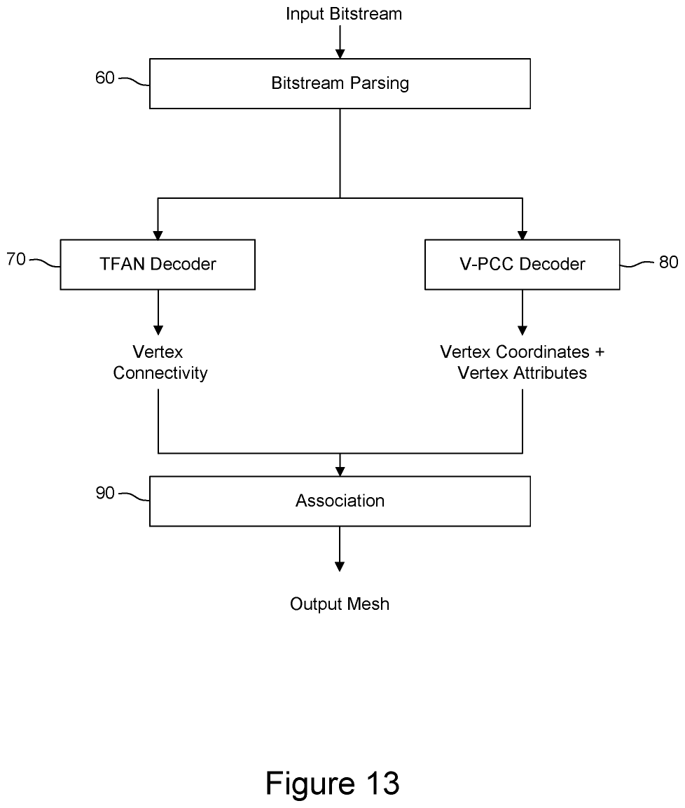

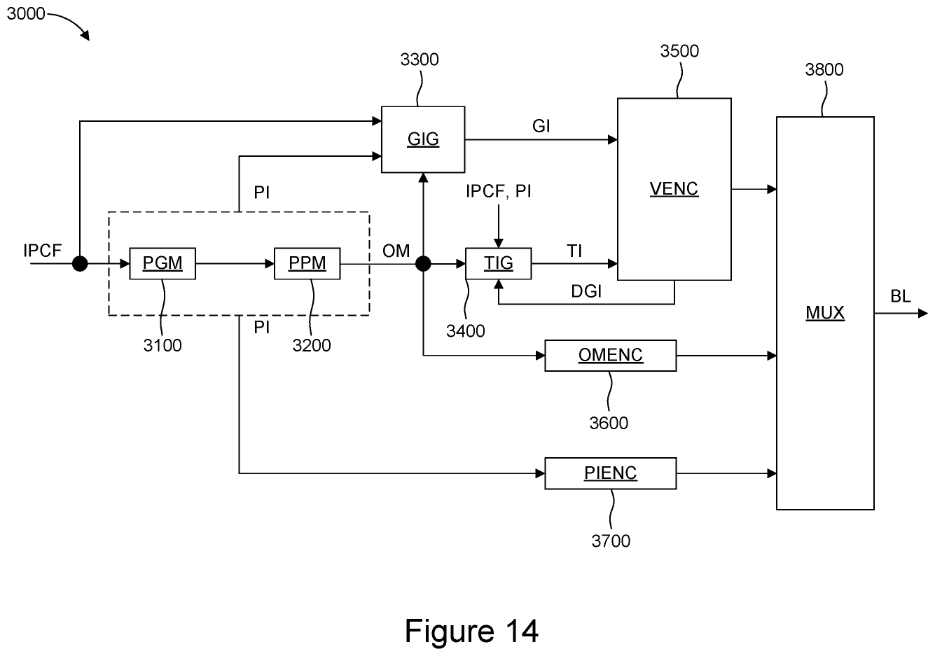

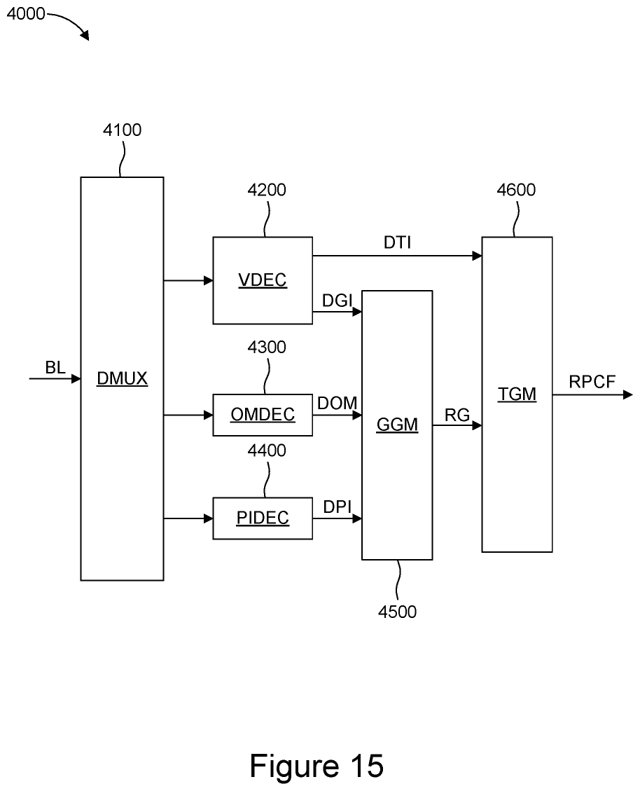

Below is proposed a flowchart of this proposal (encoder and decoder, respectively, in FIG. 12 and FIG. 13).

At the encoder side, a module 10, taking as input an input mesh, outputs connectivity information to a module 20 TFAN encoder and vertex/point coordinates and attributes to a vertex reordering module 30, whose intent is to align the placement of vertices/points with regards to TFAN and V-PCC point coding order, prior to processing the reordered vertices with a V-PCC encoder module 40. Eventually, the TFAN and V-PCC encoders' outputs are wrapped in an output bitstream, possibly compliant with an extended version of a V-PCC encoder.

At the decoder side, a module 60 parses the V-PCC mesh-extended bitstream so that a module 70 decodes the coded connectivity by a TFAN decoder while a module 80 decodes the attributes and coordinates of the associated vertices. Eventually, a module 90 combines all the decoded information to create an output mesh.

Typically, the above-described technology allows to losslessly compress mesh objects by a ratio of approximately 7 (e.g., 150 bpv->23 bpv) with respect to the original (uncompressed) mesh model.

### Detailed Description of the Solutions

The main intent behind the general aspects described herein is twofold:
Use only the V-PCC codec (but extend it to handle meshes),
Minimize changes to the current V-PCC encoder and decoder.

The current version of V-PCC codes information representative of a point cloud, i.e., attributes, occupancy map and geometry information in one so-called atlas (“a collection Modules 3600 and 4300 are removed in a proposed embodiment and new processes are added

The V-PCC encoder and decoder schemes are modified as follows:
Patch generation is modified using rasterization of the input mesh
The occupancy map is not created and transmitted in the V-PCC bitstreams
The 3D borders of the patches and the information of adjacency between the patches are transmitted.

Rather than sending the 2D occupancy map videos in the bitstream, the solution proposes to store in the bitstream:
The segments of the borders of the patches (List of 3D points that define the border segments between two patches). These lists of points are oriented and define the lists of the edges that are shared between two patches.
For each patch, the list of the adjacent patches (indices of the patches that share border segments with the current patch).

### Note:

The border segments between two patches are the same for the two corresponding patches and the border segments are stored only once. The border segments are indexed by the pair of values [n;m] corresponding to the indices of the two patches n and m.
The borders could be between two patches but could also be between one patch and nothing if the patch has a border that is not connected to any other part of the mesh. In this case, the index of the second patch used to define the two patches that share the current border segments are set to minus one (−1) and the border segment index is [n;−1].
The border segment points are oriented and must all be used directly in a clockwise order (or optionally counter clockwise if equally applied to all borders) if the current patch corresponds to the first index of the pair [n;m], and must be used in the opposite order if the current patch index corresponds to the second value of the pair [n;m].
Taking into account the previous note, the complete list of the border points of one patch could be obtained by concatenating all the border segments where the current patch index appears.

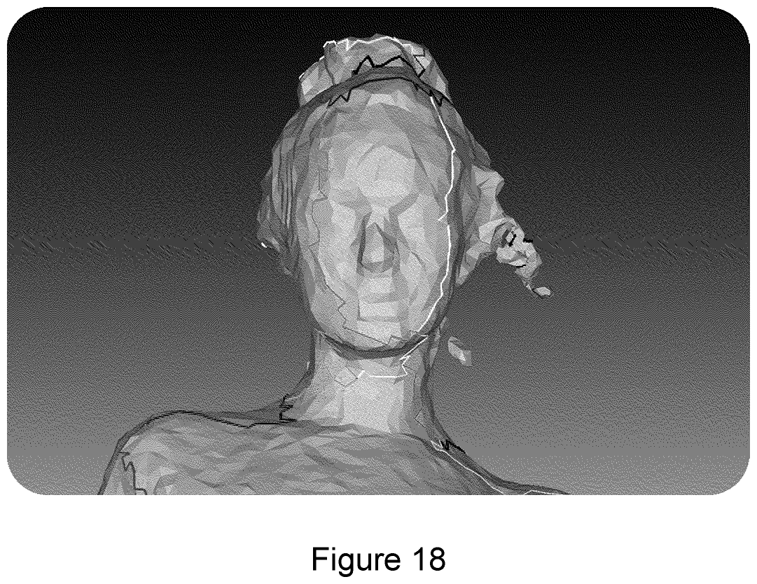

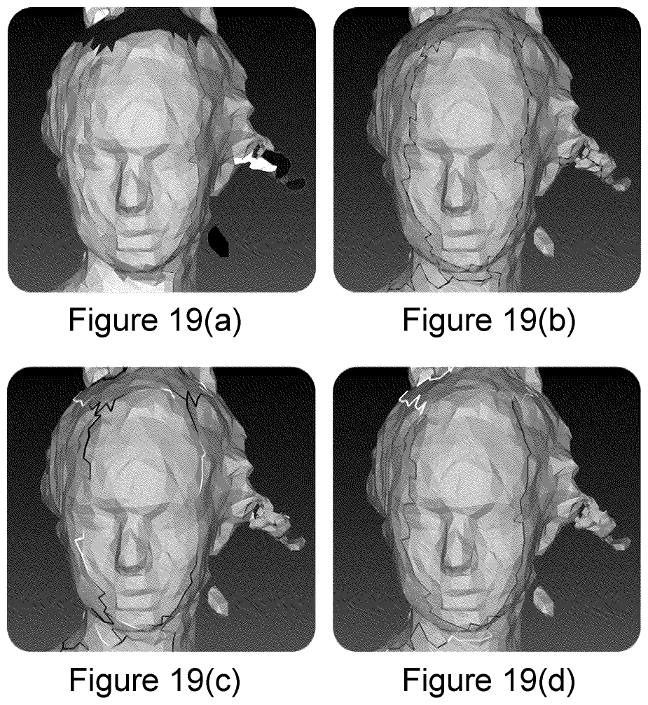

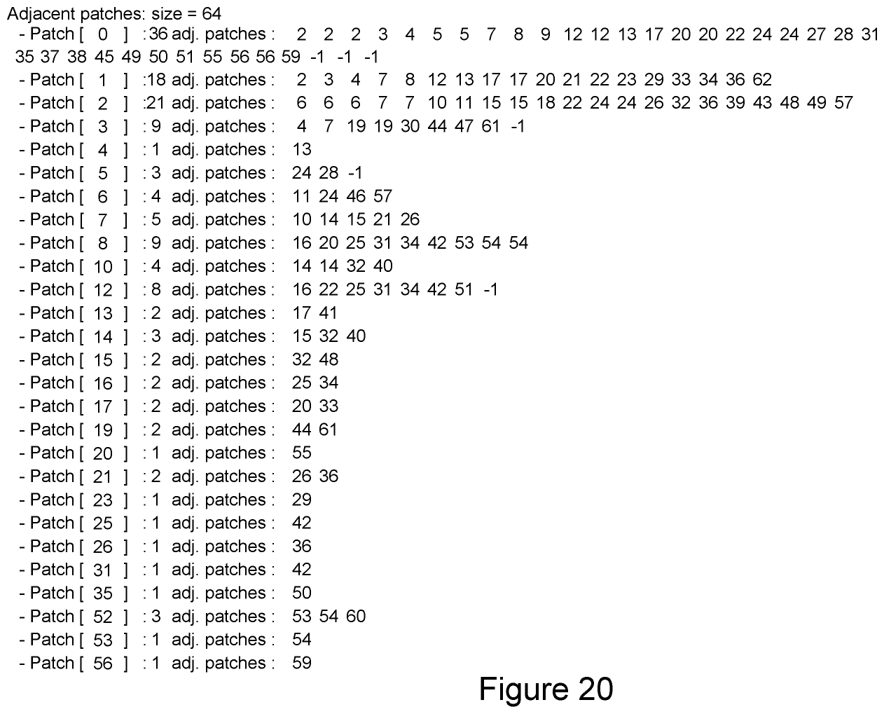

FIG. 18 shows an example of the border segments on a mesh.

### Extraction of the Border Segments of the Patches

According to the segmentation process, each triangle of the mesh is assigned to a patch and each triangle has a patch index value that indicates which patch it belongs to.

The algorithm to compute the segments of the border points of each patch and at the same time the list of the adjacent patches is described below.

For each triangle T of patch index pi(T):
For each neighbor's triangle N of T
   If the patch index of N and T are not the same (pi(T) !=pi(N))
      If two vertices of T (v0,v1) are the same in the triangle N: T and N; or
      If two vertices of T (v0,v1) are not present in any neighbor triangles N,
         Create an edge (v0,v1) in the list of the edges between the patch (min(pi(T), pi(N)), max(pi(T), pi(N))), if the same edge is not already present.

For each list of edges between two patches p0 and p1:
Find the M segments of consecutive points
Store in the list of border segments of the patch (p0,p1), the M lists of points.

This process is allowed because the triangle and the edge have been oriented clockwise in the first stage of the process.

After this process, we have Q lists of oriented points (Pi, Pj), containing the points of the border of the patches between the patches Pi and Pj. The pairs (Pi, Pj) have Pi<Pj, and Pj could be equal to −1 if the border of the patch Pi is not linked with any other patch.

These lists of border points could be used to extract all the border patches of one patch Pk, by concatenating all the lists of points where the index Pk is present in the pair (Pi, Pj). If Pj is equal to Pk, the list of points must be inversed to get the points in the clockwise order corresponding to the patch.

The set of pairs (Pi, Pj) could also be used to extract the lists of adjacent patches. The next example shows the list of adjacent patches:

Transfer of the border point segments and of the list of adjacent patches

The border point segments, and the list of adjacent patches are used by the encoder and by the decoder, and these data must be transmitted in the V-PCC bitstream.

### Border Point Segments Coding

The order of the points must be preserved, and the decoder must rebuild the list of points of each of the adjacent patches (i,j).

According to the order of the patches defined in the lists of adjacent patches in ascending order, the points of the border segments are concatenated into only one list.

To allow us to detect where a list of consecutive segments ends, the last point of each such list is duplicated.

The lists of border points may then be coded (for example, with Draco) as quantized point clouds, or any other encoder that will preserve the order of the points and their multiplicity. This encoder may be lossless or lossy.

The corresponding bitstream is stored in the V-PCC bitstream in a V3C Unit. The bitstream is stored in a V3C unit of type V3C_OVD corresponding to the occupancy video data, but another V3C unit could be used or specially defined for this.

The decoding process gets the corresponding V3C unit, decodes the data with the appropriate decoder (e.g., Draco), and obtains the list of border points containing the encoded points in the same order with the duplicate points.

According to the list of adjacent patches in ascending order, the points of the list are added to the corresponding border list points (Pi, Pj). Each detected duplicate point is used to know that the next point is the starting point of a new segment, and in this case the next pair (Pi, Pj) is fetched from the lists of the adjacent patches in ascending order.

This process is lossless, and the decoded lists of border points are the same as the encoded ones.

### List of Adjacent Patch Coding

The list of adjacent patches is required on the decoder side to reconstruct the border point segments and to reconstruct the patches, and these data must be transmitted.

This list is by patch and stores the indices of the neighboring patches. If the current frame is represented by n patches, for each patch of index I in [0;n−1], we have a list of adjacent patches: {j, k, l, m, o, . . . , [−1], [−1]}. These lists have some specific properties:
The indices stored in the list are always superior to i and inferior to n.
The stored indices are in ascending order.
The last elements of the list could be several times −1.

To code this list, we could create an intermediate list containing the delta values and code the delta list:
Per example in the list of adjacent patches {j, k, l, m, o, −1, −1}
Replace −1 by the number of patches n→{j, k, l, m, o, n, n}
Code the delta to the previous element (i+1 for the first one).→{j−i+1, k−j, l−k, m−l, o−m, n−o, 0}

On the decoder side, the opposite process can be executed to rebuild the list:
For the decoded delta list {d1, d2, d3, d4, d5, d6, d7}
Add previous elements to each element {d1+i+1, d1+i+1+d2, d1+i+1+d2+d3 . . . }
Replace by −1 the elements equal to n {d1+i+1, d1+i+1+d2, d1+i+1+d2+d3 . . . , −1, −1}

After this process, we need to code in the V3C bitstreams the delta values of the adjacent patch lists.

We must update the V3C syntax defined in w19579_ISO_IEC_FDIS_23090-5 with the following syntax elements:
8.3.7.3 Patch data unit syntax
8.3.7.5 Merge patch data unit syntax
8.3.7.6 Inter patch data unit syntax

8.3.7.3 Patch data unit syntax

| | Descriptor |
|---|---|
| patch_data_unit( tileID, patchIdx ) { | |
| pdu_2d_pos_x[ tileID ][ patchIdx ] | ue(v) |
| pdu_2d_pos_y[ tileID ][ patchIdx ] | ue(v) |
| pdu_2d_size_x_minus1[ tileID ][ patchIdx ] | ue(v) |
| pdu_2d_size_y_minus1[ tileID ][ patchIdx ] | ue(v) |
| pdu_3d_offset_u[ tileID ][ patchIdx ] | u(v) |
| pdu_3d_offset_v[ tileID ][ patchIdx ] | u(v) |
| pdu_3d_offset_d[ tileID ][ patchIdx ] | u(v) |
| if( asps_normal_axis_max_delta_value_enabled_flag ) | |
| pdu_3d_range_d[ tileID ][ patchIdx ] | u(v) |
| pdu_projection_id[ tileID ][ patchIdx ] | u(v) |
| pdu_orientation_index[ tileID ][ patchIdx ] | u(v) |
| if( afps_lod_mode_enabled_flag ) { | |
| pdu_lod_enabled_flag[ tileID ][ patchIdx ] | u(1) |
| if( pdu_lod_enabled_flag[ tileID ][ patchIdx ] > 0 ) { | |
| pdu_lod_scale_x_minus1[ tileID ][ patchIdx ] | ue(v) |
| pdu_lod_scale_y_idc[ tileID ][ patchIdx ] | ue(v) |
| } | |
| } | |
| pdu_num_adjacent_patches | ue(v) |
| for( i = 0; i < pdu_num_adjacent_patches; i++ ) { | |
| pdu_delta_adjacent_patches[i] | ue(v) |
| } | |
| if( asps_plr_enabled_flag ) | |
| plr_data( tileID, patchIdx ) | |
| } | |

8.3.7.5 Merge patch data unit syntax

| | Descriptor |
|---|---|
| merge_patch_data_unit( tileID, patchIdx ) { | |
| if( NumRefIdxActive > 1 ) | |
| mpdu_ref_index[ tileID ][ patchIdx ] | ue(v) |
| OverridePlrFlag = 0 | |
| mpdu_override_2d_params_flag[ tileID ][ patchIdx ] | u(1) |
| if( mpdu_override_2d_params_flag[ tileID ][ patchIdx ] ) { | |
| mpdu_2d_pos_x[ tileID ][ patchIdx ] | se(v) |
| mpdu_2d_pos_y[ tileID ][ patchIdx ] | se(v) |
| mpdu_2d_delta_size_x[ tileID ][ patchIdx ] | se(v) |
| mpdu_2d_delta_size_y[ tileID ][ patchIdx ] | se(v) |
| if( asps_plr_enabled_flag ) | |
| OverridePlrFlag = 1 | |
| } else { | |
| mpdu_override_3d_params_flag[ tileID ][ patchIdx ] | u(1) |
| if(mpdu_override_3d_params_flag[ tileID ][ patchIdx ] ) { | |
| mpdu_3d_offset_u[ tileID ][ patchIdx ] | se(v) |
| mpdu_3d_offset_v[ tileID ][ patchIdx ] | se(v) |
| mpdu_3d_offset_d[ tileID ][ patchIdx ] | se(v) |
| if( asps_normal_axis_max_delta_value_enabled_flag ) | |
| mpdu_3d_range_d[ tileID ][ patchIdx ] | se(v) |
| if( asps_plr_enabled_flag ) { | |
| mpdu_override_plr_flag[ tileID ][ patchIdx ] | u(1) |
| OverridePlrFlag = mpdu_override_plr_flag[ tileID ][ patchIdx ] | |
| } | |
| } | |
| } | |
| mpdu_num_adjacent_patches | ue(v) |
| for( i = 0; i < mpdu_num_adjacent_patches; i++ ) { | |
| mpdu_delta_adjacent_patches[i] | ue(v) |
| } | |
| if( OverridePlrFlag && asps_plr_enabled_flag ) | |
| plr_data( tileID, patchIdx ) | |
| } | |

8.3.7.6 Inter patch data unit syntax

| | Descriptor |
|---|---|
| inter_patch_data_unit( tileID, patchIdx ) { | |
| if( NumRefIdxActive > 1 ) | |
| ipdu_ref_index[ tileID ][ patchIdx ] | ue(v) |
| ipdu_patch_index[ tileID ][ patchIdx ] | se(v) |
| ipdu_2d_pos_x[ tileID ][ patchIdx ] | se(v) |
| ipdu_2d_pos_y[ tileID ][ patchIdx ] | se(v) |
| ipdu_2d_delta_size_x[ tileID ][ patchIdx ] | se(v) |
| ipdu_2d_delta_size_y[ tileID ][ patchIdx ] | se(v) |
| ipdu_3d_offset_u[ tileID ][ patchIdx ] | se(v) |
| ipdu_3d_offset_v[ tileID ][ patchIdx ] | se(v) |
| ipdu_3d_offset_d[ tileID ][ patchIdx ] | se(v) |
| if( asps_normal_axis_max_delta_value_enabled_flag ) | |
| ipdu_3d_range_d[ tileID ][ patchIdx ] | se(v) |
| ipdu_num_adjacent_patches | ue(v) |
| for( i = 0; i < ipdu_num_adjacent_patches; i++ ) { | |
| ipdu_delta_adjacent_patches[i] | ue(v) |
| } | |
| if( asps_plr_enabled_flag ) | |
| plr_data( tileID, patchIdx ) | |
| } | |

### Occupancy Map Reconstruction

Based on the border segments of the patches and on the lists of the adjacent patches, it is possible to build the occupancy map of a patch by computing the intersection between the border segments of the patch and the horizontal lines in the occupancy map.

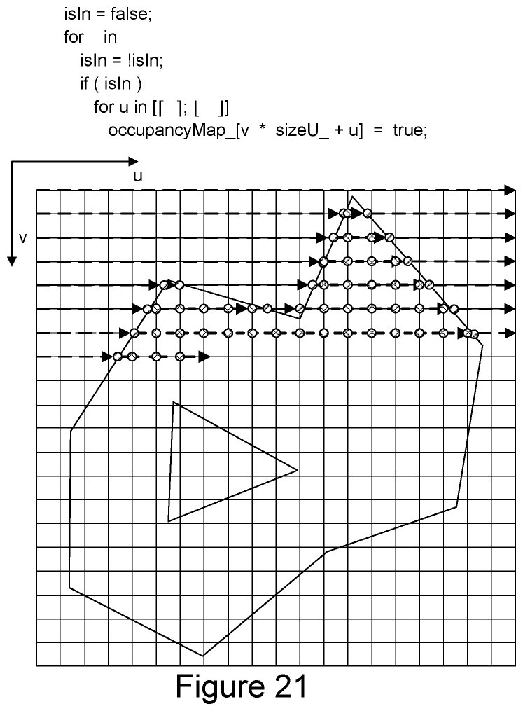

For each horizontal line of the occupancy map, we can compute the intersection points with the border segments of the patch. The list of the intersection points can be ordered according to the values of u (see FIG. 21) in ascending order, and the points can be noted: {p₀, p₁, p₂, . . . pₙ}.

A greedy algorithm can process the list of points and for each point pi, inverse the value of a flag marking whether the intersection after the point is inside or ouside the patch, and if the intersection [pᵢ,pᵢ₊₁] is in the patch, set the occupancy map pixels in this intersection to true.

FIG. 21 shows an example of this process.

Additionally, to the information of occupation stored in the occupancy map, the proposed algorithm, that builds the occupancy map, stores for each occupied point a link to the intersection points {B₀, B₁, . . . } between the border segments and the horizontal/vertical lines. Each border point of the occupancy map stores the nearest intersection points on the border segments in both u and v directions.

The intersection points are also added in the oriented list of the border segment points noted: {S₀, B₀, B₁, . . . Bₙ, S₁, Bₙ₊₁, Bₙ₊₂, . . . Bₙ₊ₘ, S₂ . . . }, where Sᵢ are the points of the border segments of the patch and Bᵢ the intersection points. This list is named S′ and stored in memory for later use. The S′ list is not coded in the bitstream, like the list of the border segments of the patches as presented in [1], but will be reconstructed, like the occupancy maps, by the decoding process.

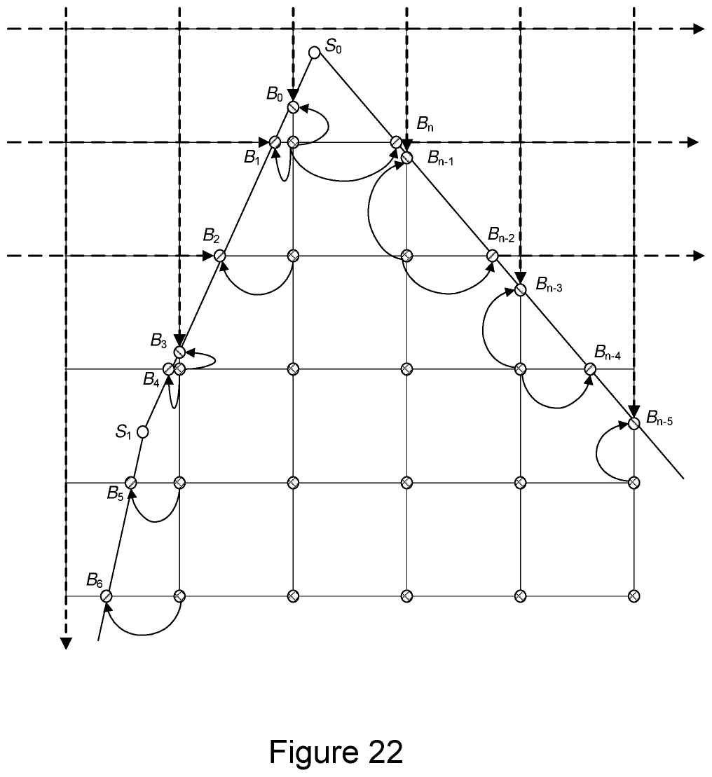

FIG. 22 shows an example of this process.

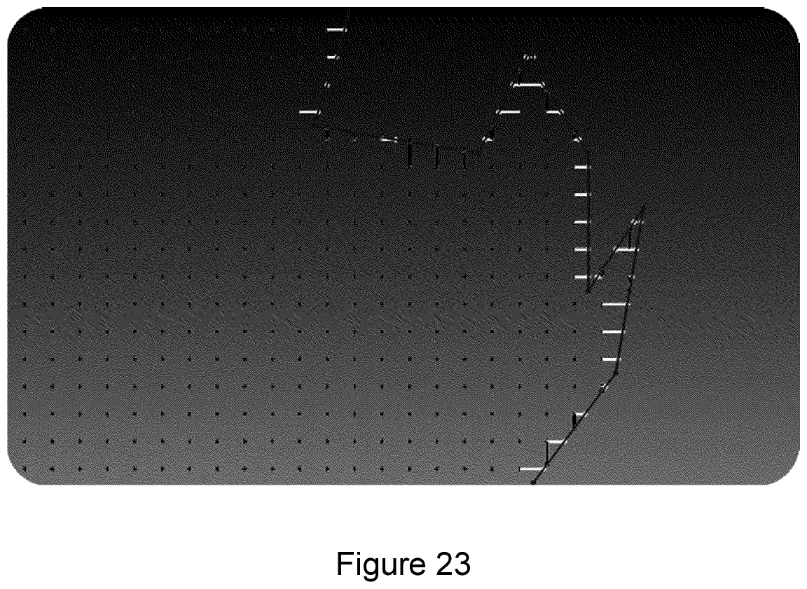

FIG. 23 shows an example of this process on a real patch.

### Reconstruction of the 3D Meshes of the Patches

According to the occupancy maps, the decoded geometry video, the border segments and the intersection points of the border segments (stored in S′), we can reconstruct the 3D mesh corresponding to each patch and directly fill the inter-patch space to be sure that the reconstructed patch covers all the space defined by the border segments. In this case, the additional process that fills the space between the patches (as proposed in the first approach) is not required because the inter-patch spaces are already covered by the reconstructed patches.

The reconstruction process proposed in the first approach has therefore been updated to directly fill the inter-patch spaces.

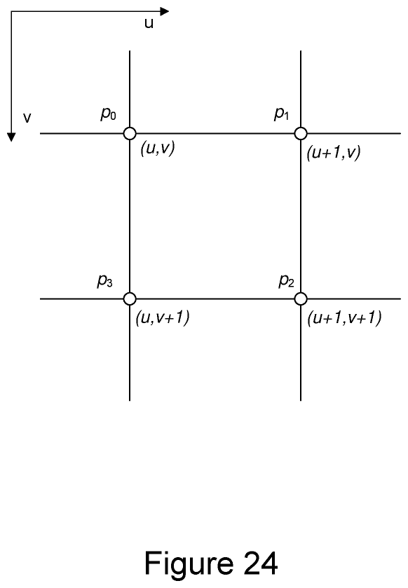

To allow a parallel reconstruction of a patch by a GPU shader, each occupied (u,v) pixel of the occupancy map could be reconstructed in parallel, followed by the reconstruction of the mesh corresponding to the square defined by the four points: (u,v), (u+1,v) (u+1,v+1) and (u, v+1), where these points are noted: p₀, p₁, p₂ and p₃, as shown in the example in FIG. 24.

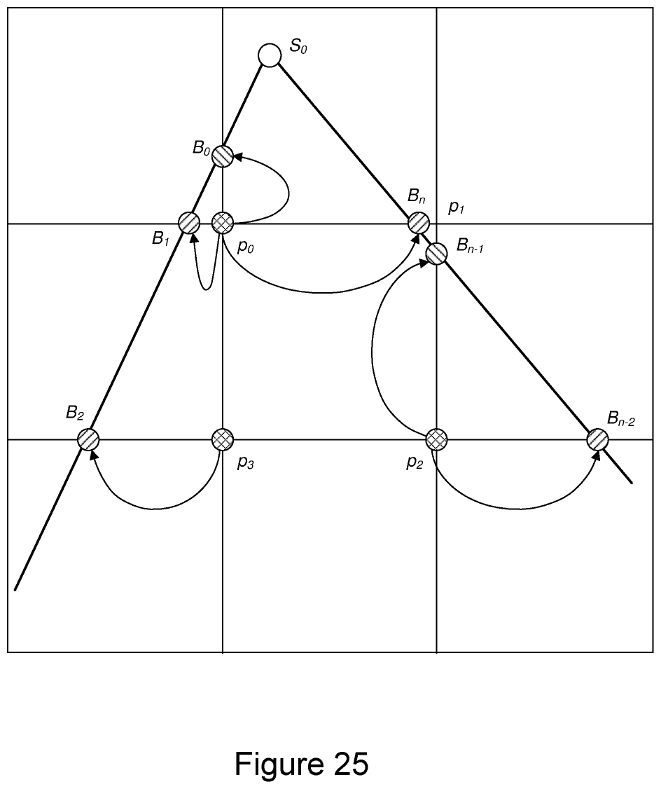

Each point (u,v) of the occupancy map has a list of intersection points Bᵢ. Only the points that are in the square [p₀, p₁, p₂, p₃] must be considered as shown in FIG. 25.

According to the numbers of occupied points on the four corners of the square, an ad hoc reconstruction using a specific meshing pattern is performed, as detailed in the sub-sections below.

To limit the number of cases that must be considered and the complexity of the reconstruction process, the border segments are simplified during the encoding process to guarantee that only one point Sᵢ is present in each 3D voxel of size one. After this simplification, we know that only one point Sᵢ can be present in each square: (p₀, p₁, p₂, p₃)

### One Occupied Point

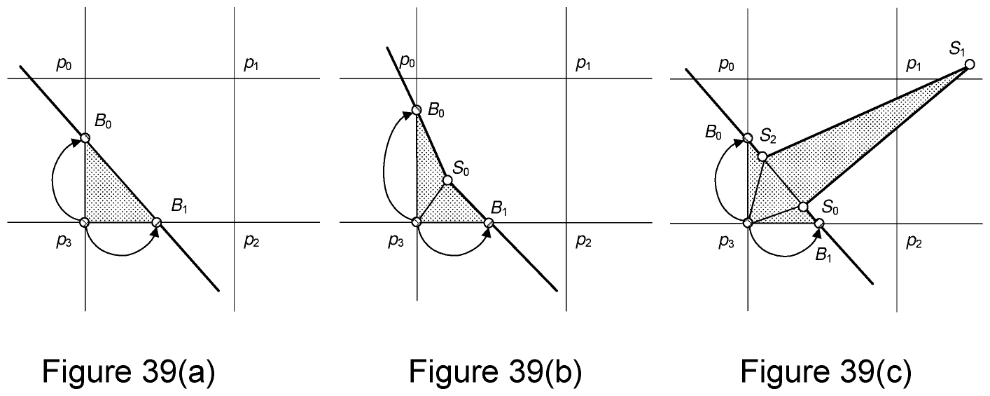

If only one point is occupied, for example p₃ as shown in FIG. 39 we know that the occupied point has two intersection points B₀ and B₁ on their adjacent edges [p₀; p₃] and [p₃; p₂], and we build the list of the border points of the corresponding reconstructed mesh with B₀, p₃ and B₁. To know if some points must be inserted between B₀ and B₁, we could study the list S′ and add all the points of this oriented list between B₀ and B₁ as shown in FIG. 11b and FIG. 11c. The resulting list is well oriented without intersection and can be easily triangulated.

Note: As shown in FIG. 11c, the reconstructed mesh could be outside the square [p₀, p₁, p₂, p₃]. This point is true only if only one point is occupied in the square.

### Two Occupied Points

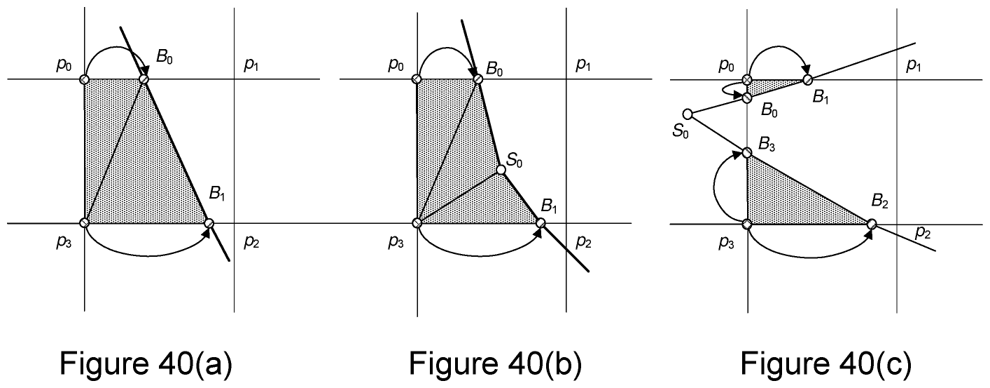

If two points are occupied, for example p₃ and p₀ as shown in FIG. 40 the process below can be followed to re-mesh the corresponding space.

If the two points have only one intersection point Bᵢ each, we could build the list B₀, p₀, p₃, B₁, and the points of S′ between B₀ and B₁, to triangulate this polygon (FIG. 40a and FIG. 40b).

If the two points have two intersection points each, as shown in FIG. 40c, each occupied point must be rebuilt independently, and the reconstructed process described in One Occupied Point section must be used.

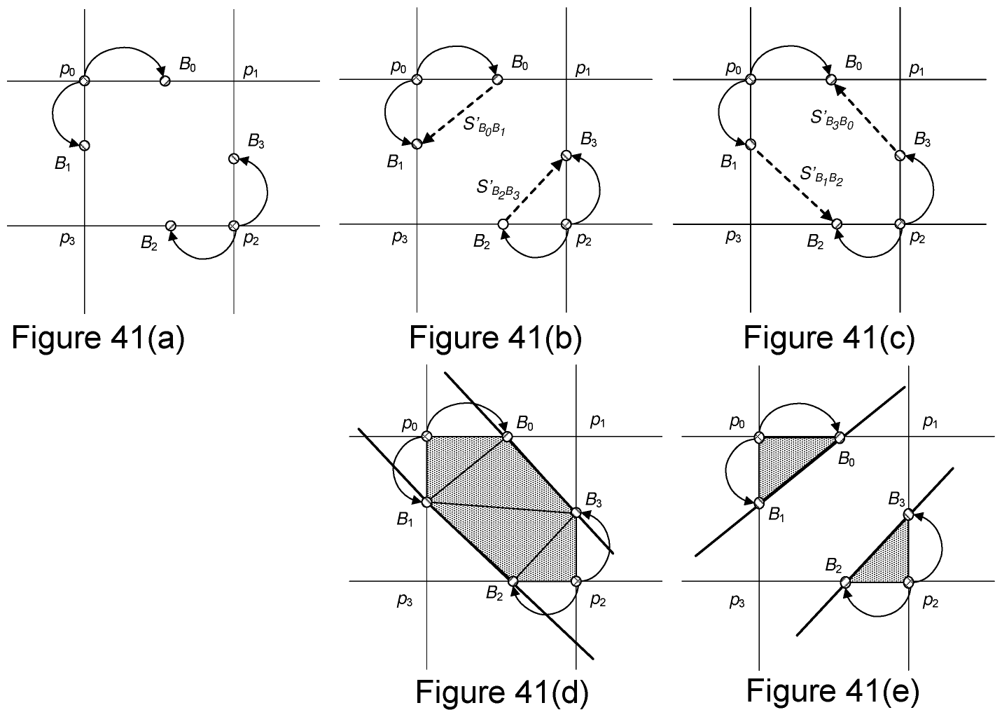

If the two occupied points are not adjacent (p₀ and p₂ or p₁ and p₃), as shown in FIG. 41a, each occupied point has two intersection points, but the border segments can be around the two points (FIG. 41d) or the two points can be separated by two border segments (FIG. 41e). In these cases, the length of the border segments between the intersection points Bᵢ must be studied in S′ to evaluate in which case we are.

To separate these two cases, we can compute four sub-segments of S′:
S′_{B}_{₀}_{B}_{₁}: containing the points of S′ between the two intersection points, B₀ and B₁, of the first occupied points p₀ (FIG. 41b).
S′_{B}_{₂}_{B}_{₃}: containing the points of S′ between the two intersection points, B₂ and B₃, of the second occupied points p₁ (FIG. 41b).
S′_{B}_{₁}_{B}_{₂}: containing the points of S′ between:
   the second intersection points B₁ of the first occupied points p₀, and;
   the first intersection points B₂ of the second occupied points p₁ (FIG. 41c).
S′_{B}_{₃}_{B}_{₀}: containing the points of S′ between:
   the second intersection points B₃ of the second occupied points pᵢ, and;
   the first intersection points B₀ of the second first points p₀ (FIG. 41c).

The numbers of points in the sub-segments are used to know if the points are inside or outside the border segments, and according to this a specific reconstruction process is performed. In the following formula, we use the notation | . . . | to represent the number of points in the sub-segment.

If |S′_{B}_{₀}_{B}_{₁}|+|S′_{B}_{₂}_{B}_{₃}|<|S′_{B}_{₁}_{B}_{₂}|+|S′_{B}_{₃}_{B}_{₀}|, each occupied point must be rebuilt independently, and the reconstructed process described in One Occupied Point section must be used (FIG. 41e).

If |S′_{B}_{₁}_{B}_{₂}|+|S′_{B}_{₃}_{B}_{₀}|<|S′_{B}_{₀}_{B}_{₁}|+|S′_{B}_{₂}_{B}_{₃}|, we could build the list B₀, p₀, B₃, B₂, p₂, B₁, and the points of S′ between B₀ and B₁ and the points of S′ between B₃ and B₂ to triangulate (FIG. 41d).

### Three Occupied Points

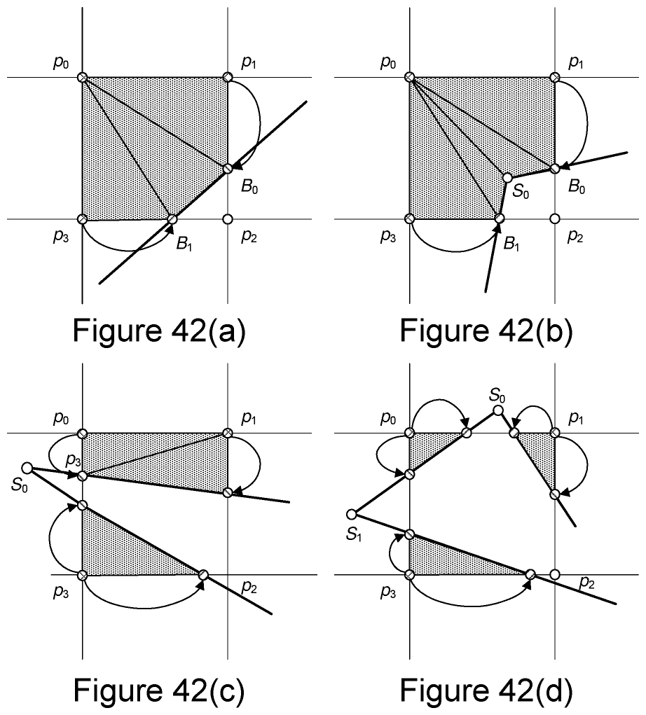

If three points are occupied, for example p₀, p₁ and p₃ as shown in FIG. 42, the process below can be carried out to re-mesh the corresponding space.

If two points have one border point and the other point has no border points (FIGS. 42a and b), we can build the list of the border points of the reconstructed mesh with the points in oriented order: B₀, p₁, p₀, p₃, B₁ and complete the list with the points of S′ between B₀ and B₁. This list could be triangulated to build the mesh.

If one point has two intersection points and the two other points have only one intersection point each, we could use the previously described processes to re-build the mesh (FIG. 42c).

If the three points have two border points each, we could use the previously described process in One Occupied Point to re-build the mesh (FIG. 42d).

### Four Occupied Points

If four points of the square are occupied, we could study the number of intersection points of each point to reconstruct the mesh.

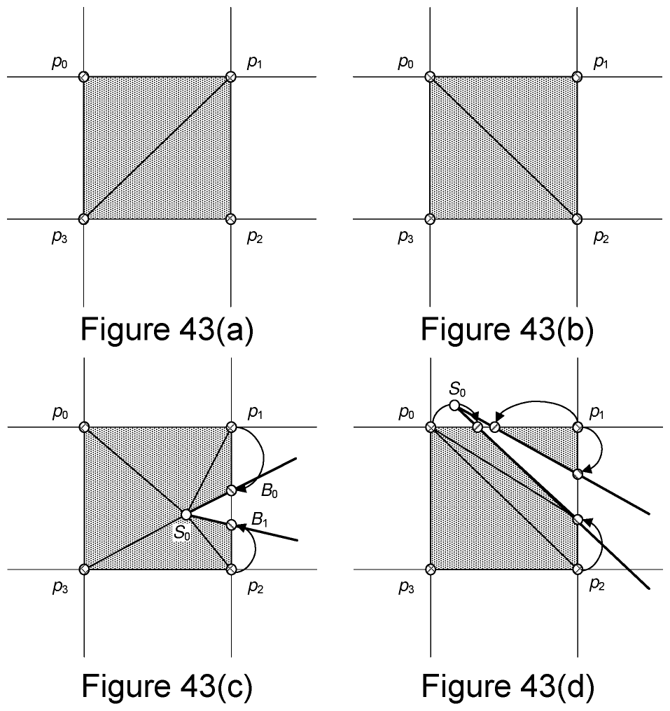

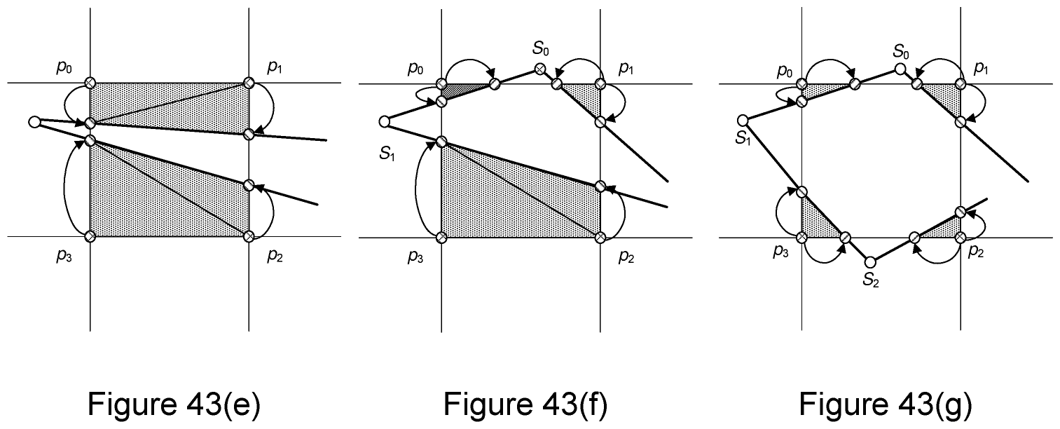

If no border point is present for any points, the square has no intersection with the border segments and the square must be fully triangulated. According to the modulo of the u and v coordinates, the two created triangles to represent the square are (p₀, p₁, p₃) and (p₁, p₂, p₃) or (p₀, p₁, p₂) and (p₀, p₂, p₃) to guarantee that the complete patch will be meshed by diamond oriented triangles (FIG. 43a and FIG. 43b).

If only two occupied points have one intersection point each, we can build the list of the border points of the reconstructed mesh with the points in oriented order: B₀, pᵢ, p₀, p₃, p₂, B₁, and the points of S′ between B₀ and B₁. This list could be triangulated to build the mesh (FIG. 43c).

The other cases can be rebuilt by using the previous reconstruction processes based on one, two or three occupied points described in the previous sections.

If a point has two intersection points, the point is isolated, and the process described in section on one occupied point must be used (FIG. 43d, FIG. 43f and FIG. 43g).

If two adjacent points have only one intersection point each, the process described in section on two occupied points must be used (FIG. 43e, and FIG. 43f).

If three adjacent points have one intersection point for the first one and the third one and no intersection point for the second one, the process described in section on three occupied points must be used (FIG. 43d).

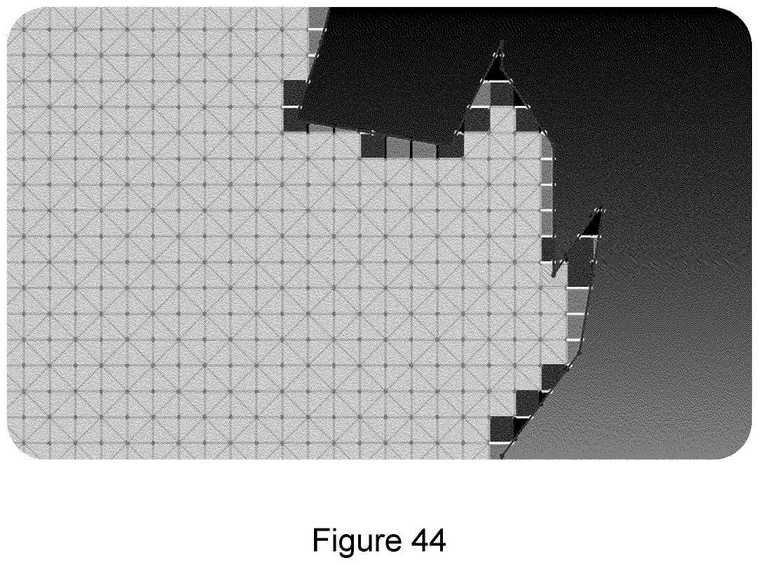

FIG. 44 shows an example of application of the previously described processes on a real patch.

### Possible Evolutions

The processes described below can work with any kind of meshes in floating point coordinates with the positions of the points of the border segments not aligned with the 2D grid of the patches. If the points of the input meshes are quantized on a regular grid, we can align the 2D grid of the patches with the 3D grid used to quantize the input meshes and in this case the positions of the points of the border segments of the patches (Sᵢ) will be on the vertices of the 2D squares (Bⱼ) and the previous described reconstruction process will be simpler.

An evolution of the proposed algorithm can be to store on the intersection points (Bⱼ) the index of the segment which created this intersection point. This information can be used to know if two intersection points come from the same segment of the border segments and in this case directly triangulate the space without build and study the list S′ of the intersection points between them. On the FIG. 39a, the two intersection points B₀ and B₁ come from the same segment and could be directly triangulated. contrary to FIG. 39b where the points B₀ and B₁ not come from the same segment and in this case the list S′ of the points between B₀ and B₁ must be built to add the point S₀ in the triangularization process.

### Encoding Process

According to the previous descriptions, the encoding process is summarized below.

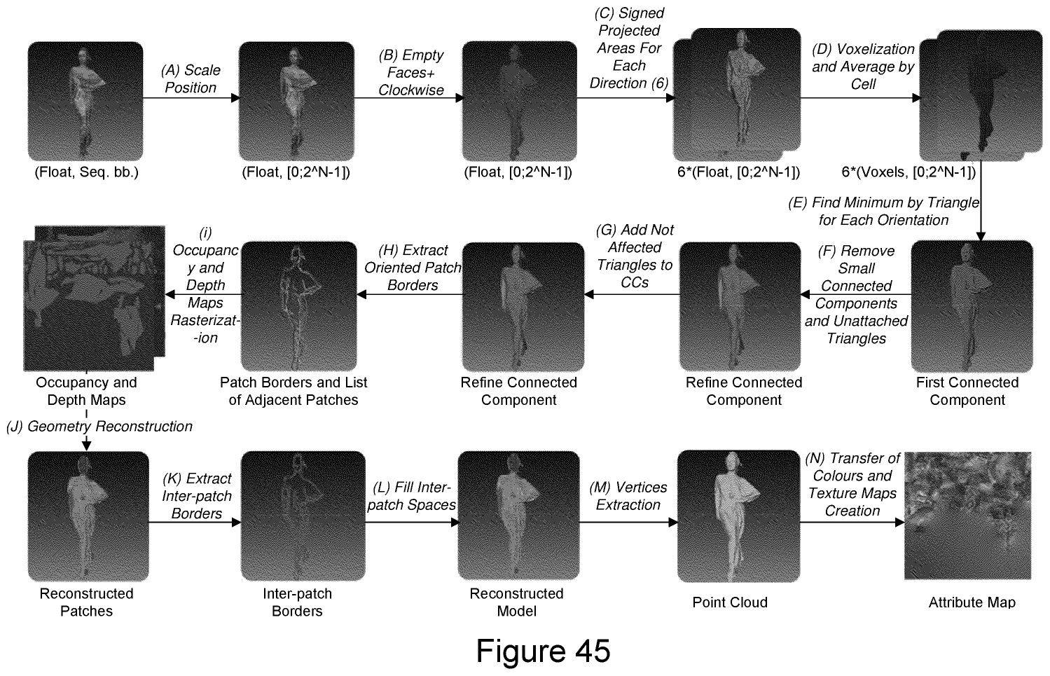

FIG. 45 shows the main stages of the encoding and segmentation processes that convert mesh models to patch information and 2D videos, which can be transmitted in the V-PCC bitstream.

The new proposed processes update the points:
FIG. 45i: Occupancy rasterization is now described in the section on occupancy map reconstruction. (Note: the rasterization of the depth map is not changed)
FIG. 45j: Geometry reconstruction.

And remove processes:
FIG. 45k: Extract inter-patch borders
FIG. 45l: Fill inter patch spaces

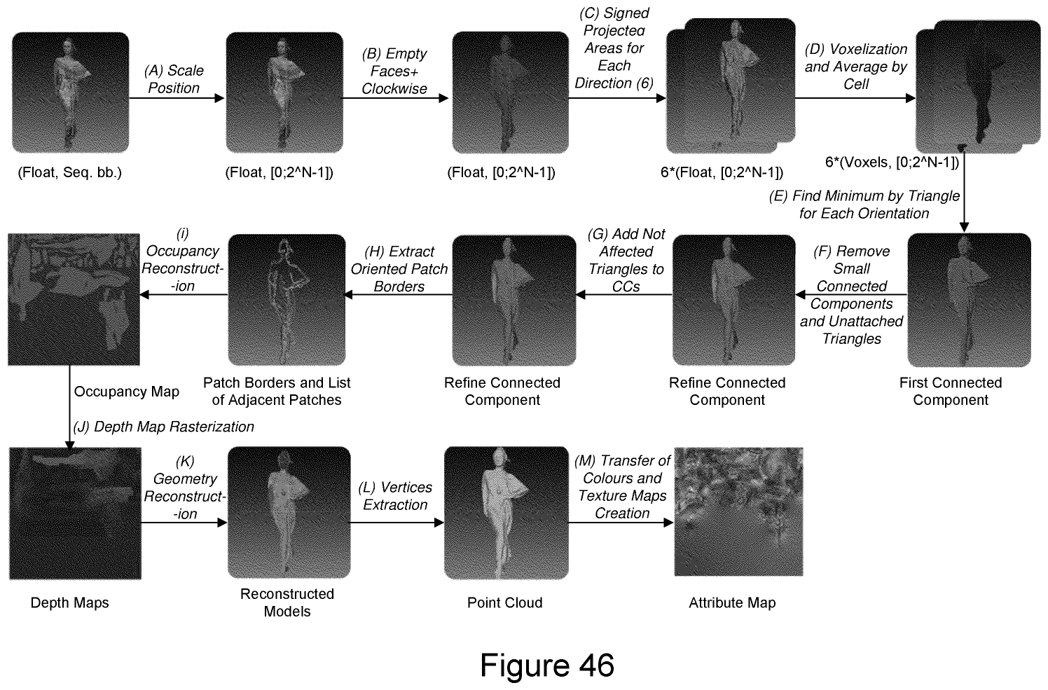

FIG. 46 presents the updated coding scheme.

### Decoding Process

The decoded process is also simplified by the new proposed processes.

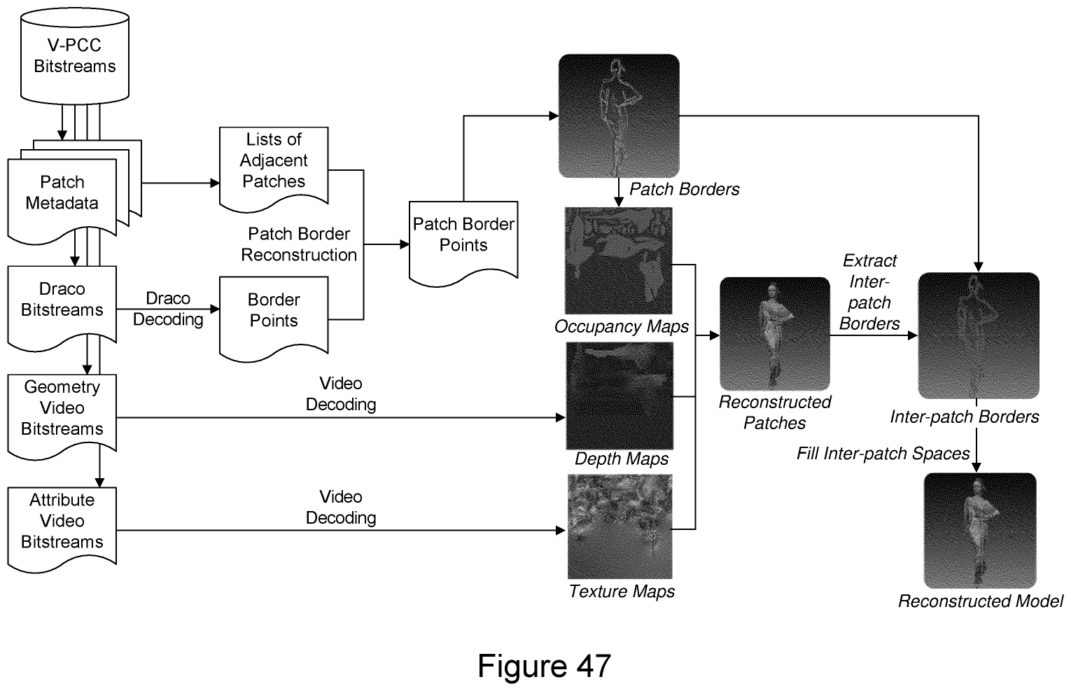

The new processes update the points described in FIG. 47:
Occupancy rasterization is now replaced by section on occupancy map reconstruction
Geometry reconstruction.

And remove processes:
Extract inter-patch borders
Fill inter patch spaces

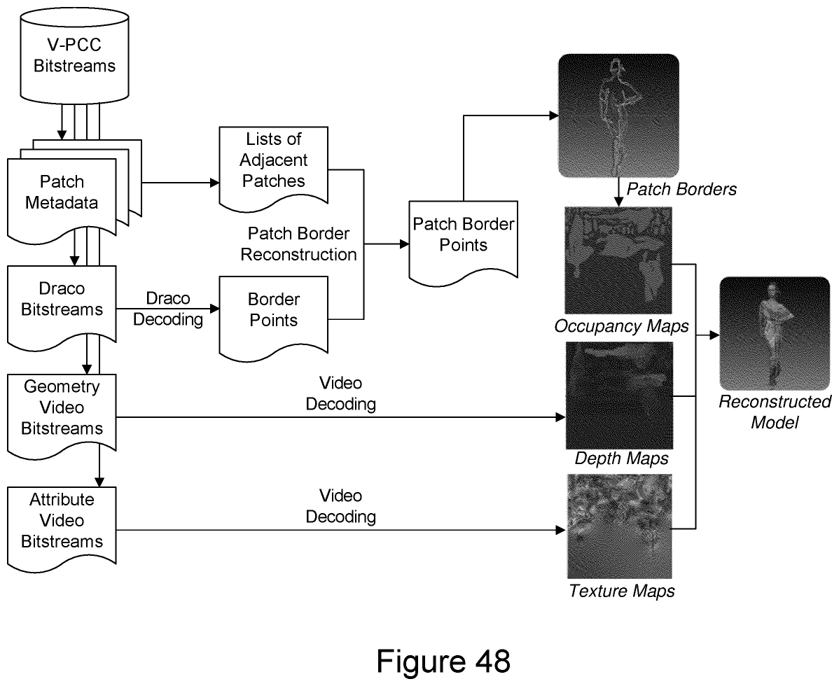

FIG. 48 presents the updated decoding scheme.

### Depth Map Filtering Based on the Border Segments

The segments of border points of the patches are coded losslessly so we can be sure that the positions of these points are correct.

In lossy mode, the geometry maps have been compressed with a video encoder and some disturbances appear on the values of depths. Due to the depth filling processes and to the values of the neighborhood patches stored in the depth maps, we can observe that more disturbances appear on the borders of the patches or on the patch area near the borders of the patches.

Knowing, on the decoded side, the exact positions of the border points, we can correct the depth values of the pixels of the depth map close to the edges of the border segments.

According to the patch parameters, we can project the border segments in the depth map and correct the pixel values of the depth maps with the computed depths during the rasterization of the border edges.

Following this process, the pixel values of the depth map (D) corresponding to the border of the patch are exact and it is interesting to propagate this information inside the patch to also correct the close border pixel values.

For this, a second depth map (R) is used to store the exact depth values of the patches computed with the positions of the 3D border points. The border points are rasterized in this second depth map according to the patch parameters, and the values of the other pixels are set with a mipmap dilation.

This procedure is not limited to this implementation:

For each pixel (u,v) of the depth map D:
if the distance d to the border segments is less than a threshold (t)
   the pixel value of D is updated according to the following formula:

$$D ( u , v ) = \frac{d}{t} \cdot D ( u , v ) + \frac{t - d}{t} \cdot R ( u , v )$$

### Simplify Patch Border Segments

The coordinates of the border points must be coded with Draco as explained in an earlier section. For the low bitrate experiments, the size of the Draco bitstreams could be important and so it is valuable to reduce the size of this data.

To reduce the size of the Draco bitstreams, we need to reduce the number of points used to describe the borders of the patches.

Knowing the points of the border segments, we could use several algorithms to clean the segments of border points. In our implementation, we use the Douglas-Peucker algorithm to remove the points of the segments that are less representative.

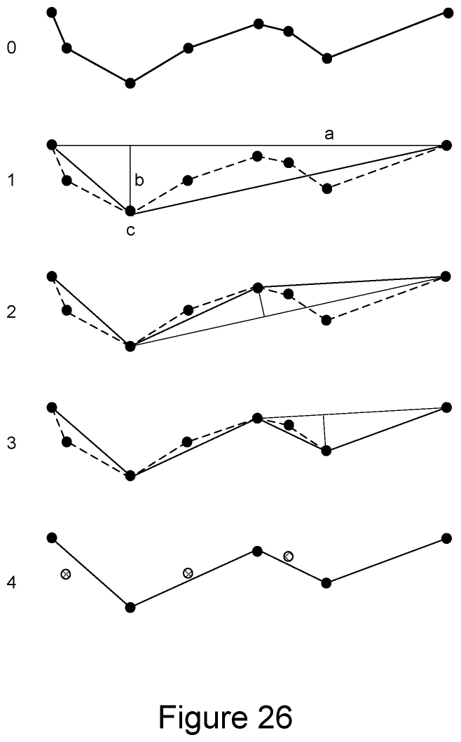

FIG. 26 shows an example of such a simplification performed on a simple 2D polyline.

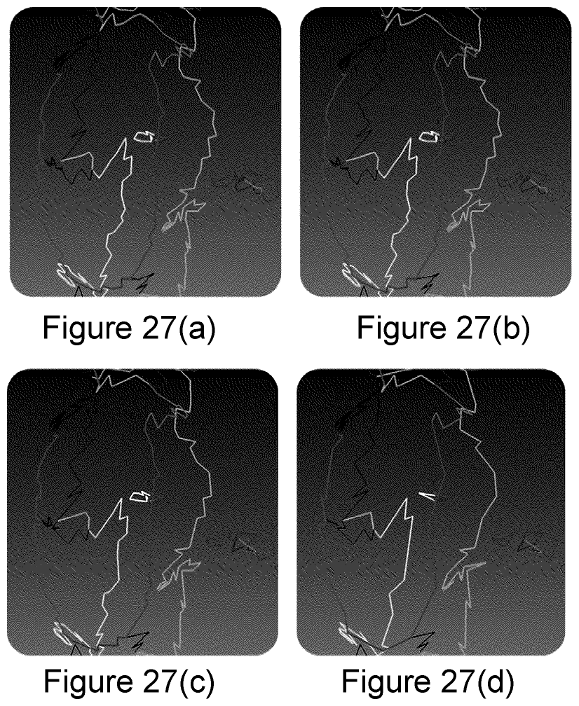

Based on this process and according to one threshold parameter, we can simplify the 2D segments of border points. FIG. 27 shows an example of simplified border segments.

The next table shows the gain in terms of the number of edges when using this kind of simplification.

| | Number of | Reduction w.r.t |
|---|---|---|
| | edges | the original |
| Original | 2910 | 100.00% |
| Threshold = 1 | 2555 | 87.80% |
| Threshold = 2 | 2054 | 70.58% |
| Threshold = 4 | 1213 | 41.68% |
| Threshold = 8 | 456 | 15.67% |
| Threshold = 16 | 233 | 8.01% |
| Threshold = 32 | 166 | 5.70% |

Another process that can be used to simplify the border segments is to compute the minimum path on a mesh between two vertices based on the Dijkstra algorithm. Based on some parameters, the list of the points of each border segment (L) are simplified based on some very simple rules: keep the first and the last point, remove one point in N, keep the extremum point, . . . ). This shortened list of points is named S. After the first stage, for each point in S, we add in the final list F the shortest path computed with Dijkstra's algorithm between the current point (s(i)) and the next point in S (s(i+1)).

This process creates a smoother border with fewer points in the border segments.

### Scale Depth of the Patches

In V3CN-PCC, the value of the depths stored in the depth maps are integer values in the range [0, 2^{N}−1], with N the bit depth of the video, and in the reconstruction process the values of depth are used to reconstruct the geometry. The normal coordinates of the reconstructed points are also integer values. This method is good for encoding point clouds that have been quantized on the discrete grid with all points in integer coordinates, but there are some issues when coding the depth values of the center points of a discrete edge.

If the two vertices v1 and v2 of an edge are quantized, then the coordinates of the points are integer values (x1, y1, z1) and (x2, y2, z2), respectively. The projection of the normal coordinates in the depth maps (for example the Z coordinate) will give for the two points the values of depth: z1 and z2, respectively, which are integer values.

For example, the projection of the center of the edge (v1,v2): v3((x2-x1)/2, (y2-y1)/2, (z2-z1)/2), will give the value of depth: (z2-z1)/2, which is not an integer value. To be coded in the depth maps, this value must be truncated and only the integer part of the depth must be kept.

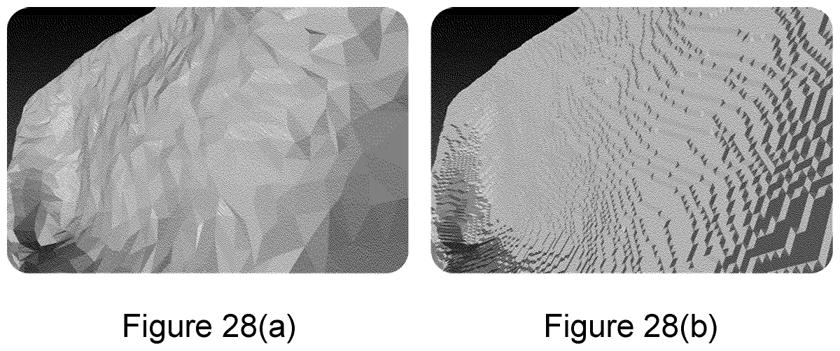

After this, the reconstructed mesh will be aliased. FIG. 28 shows an example of this issue.

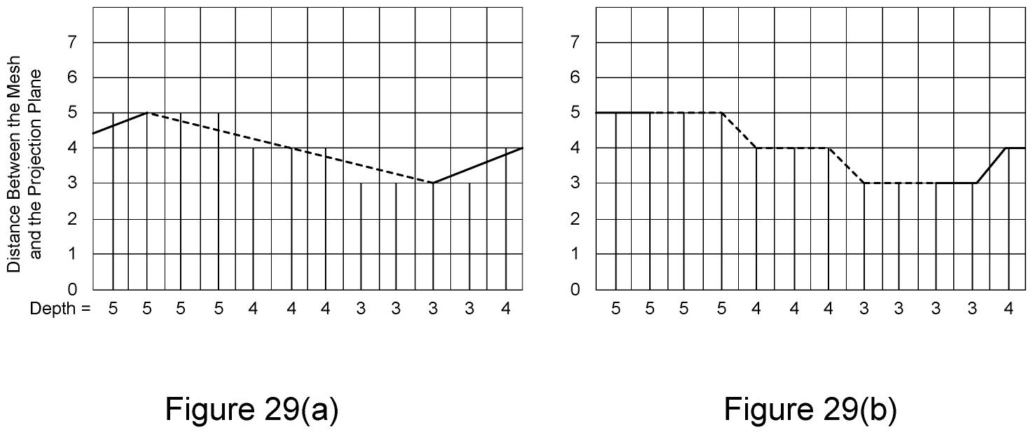

FIG. 29 shows an example of this issue in 2D. On the left, the edge of the original mesh is in blue. The two values of the depth for the two vertices are correctly set in the depth map, and the corresponding points are well reconstructed on the right. But for the intermediate points, the values of depth are truncated, and the reconstructed segment is not correct.

To limit the effect of this issue, we propose to scale the value of the depth stored in the depth map according to:
The bit depth of the video used to store the depth values
The maximum depth of the current patch.

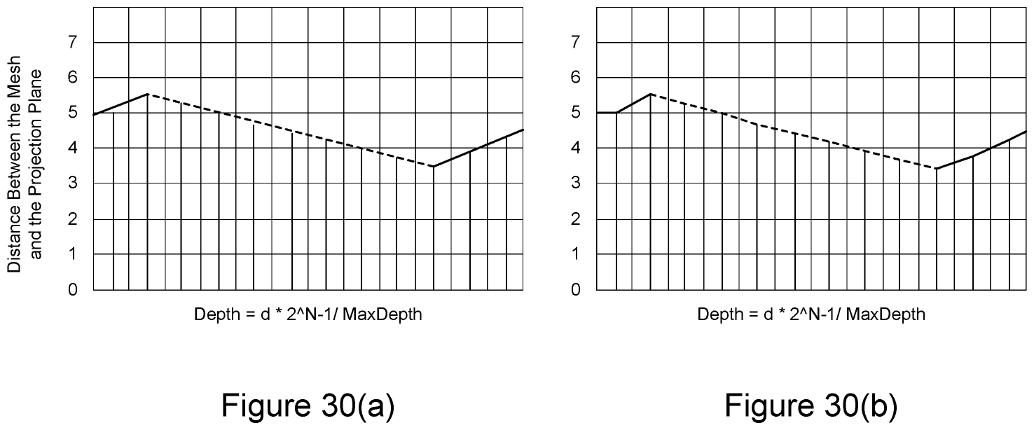

The value of the depth could be linearly scaled according to the formula:

$$Q ( d ) = \frac{d * ( {2}^{N} - 1 )}{Max Depth}$$

Where N is the bit depth of the video and MaxDepth is the value of the depth. This value could be computed based on all the depth values of the patch but could also be sent in the bitstream to allow more precise reconstruction. FIG. 30 shows an example of this process in 2D.

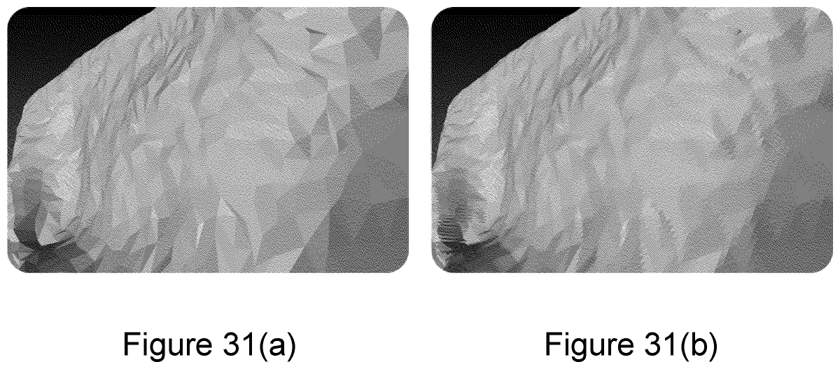

FIG. 31 shows an example of a 3D reconstructed patch with the scaling of the depth.

To allow this process, the V3CN-PCC syntax must be updated to indicate that the depth values of the current patch need to be scaled before the reconstruction process. The updated syntax will affect the V3C syntax defined in wu9579_ISO_eE(_FDIS_23090-5 and the following syntax elements:
8.3.7.3 Patch data unit syntax
8.3.7.5 Merge patch data unit syntax
8.3.7.6 Inter patch data unit syntax
A) Code a flag to indicate whether the depth must be scaled or not:

8.3.7.3 Patch data unit syntax

| | Descriptor |
|---|---|
| patch_data_unit( tileID, patchIdx ) { | |
| pdu_2d_pos_x[ tileID ][ patchIdx ] | ue(v) |
| pdu_2d_pos_y[ tileID ][ patchIdx ] | ue(v) |
| pdu_2d_size_x_minus1[ tileID ][ patchIdx ] | ue(v) |
| pdu_2d_size_y_minus1[ tileID ][ patchIdx ] | ue(v) |
| pdu_3d_offset_u[ tileID ][ patchIdx ] | u(v) |
| pdu_3d_offset_v[ tileID ][ patchIdx ] | u(v) |
| pdu_3d_offset_d[ tileID ][ patchIdx ] | u(v) |
| if( asps_normal_axis_max_delta_value_enabled_flag ) | |
| pdu_3d_range_d[ tileID ][ patchIdx ] | u(v) |
| pdu_projection_id[ tileID ][ patchIdx ] | u(v) |
| pdu_orientation_index[ tileID ][ patchIdx ] | u(v) |
| if( afps_lod_mode_enabled_flag ) { | |
| pdu_lod_enabled_flag[ tileID ][ patchIdx ] | u(1) |
| if( pdu_lod_enabled_flag[ tileID ][ patchIdx ] > 0 ) { | |
| pdu_lod_scale_x_minus1[ tileID ][ patchIdx ] | ue(v) |
| pdu_lod_scale_y_idc[ tileID ][ patchIdx ] | ue(v) |
| } | |
| } | |
| pdu_scale_depth_flag | u(1) |
| if( asps_plr_enabled_flag ) | |
| plr_data( tileID, patchIdx ) | |
| } | |

Note 1:
same line can be added in 8.3.7.5 Merge patch data unit syntax and 8.3.7.6 Interpatch data unit syntax to code respectively the mpdu_scale_depth_flag and ipdu_scale_depth_flag.
Note 2:
this new flag can be not coded in the bitstream and copy from the reference patch for the inter and merge patches. In this case, the section 9.2.5.5.1 “General decoding process for patch data units coded in inter prediction mode” from w19579_ISO_IEC_FDIS_23090-5 document must be updated to explain the copy of this value from reference patch to inter patch, or respectively section 9.2.5.4 “Decoding process for patch data units coded in merge prediction mode” for the merge patch. The copy function can be: TilePatchScaleDepthValue[ tileID ][ p ] = refPatchScaleDepthValue

B) Code a maximum depth value that will be used to scale the depth values.

8.3.7.3 Patch data unit syntax

| | Descriptor |
|---|---|
| patch_data_unit( tileID, patchIdx ) { | |
| pdu_2d_pos_x[ tileID ][ patchIdx ] | ue(v) |
| pdu_2d_pos_y[ tileID ][ patchIdx ] | ue(v) |
| pdu_2d_size_x_minus1[ tileID ][ patchIdx ] | ue(v) |
| pdu_2d_size_y_minus1[ tileID ][ patchIdx ] | ue(v) |
| pdu_3d_offset_u[ tileID ][ patchIdx ] | u(v) |
| pdu_3d_offset_v[ tileID ][ patchIdx ] | u(v) |
| pdu_3d_offset_d[ tileID ][ patchIdx ] | u(v) |
| if( asps_normal_axis_max_delta_value_enabled_flag ) | |
| pdu_3d_range_d[ tileID ][ patchIdx ] | u(v) |
| pdu_projection_id[ tileID ][ patchIdx ] | u(v) |
| pdu_orientation_index[ tileID ][ patchIdx ] | u(v) |
| if( afps_lod_mode_enabled_flag ) { | |
| pdu_lod_enabled_flag[ tileID ][ patchIdx ] | u(1) |
| if( pdu_lod_enabled_flag[ tileID ][ patchIdx ] > 0 ) { | |
| pdu_lod_scale_x_minus1[ tileID ][ patchIdx ] | ue(v) |
| pdu_lod_scale_y_idc[ tileID ][ patchIdx ] | ue(v) |
| } | |
| } | |
| pdu_scale_depth_value | ue(v) |
| if( asps_plr_enabled_flag ) | |
| plr_data( tileID, patchIdx ) | |
| } | |

Note:
same line can be added in 8.3.7.5 Merge patch data unit syntax and 8.3.7.6 Interpatch data unit syntax to code respectively the mpdu_scale_depth_value and ipdu_scale_depth_value.
Note 2:
this new value can be not coded in the bitstream and copy from the reference patch for the inter and merge patches. In this case, the section 9.2.5.5.1 “General decoding process for patch data units coded in inter prediction mode” from w19579_ISO_IEC_FDIS_23090-5 document must be updated to explain the copy of this value from reference patch to inter patch, or respectively section 9.2.5.4 “Decoding process for patch data units coded in merge prediction mode” for the merge patch. The copy function can be: TilePatchScaleDepthValue[ tileID ][ p ] = refPatchScaleDepthValue

Note 3: Additionally, to the note 2, a delta value can also be stored in a bitstream in the merge and inter patch and in this case the syntax must be updated as follows:

8.3.7.5 Merge patch data unit syntax

| | Descriptor |
|---|---|
| merge_patch_data_unit( tileID, patchIdx ) { | |
| if( NumRefIdxActive > 1 ) | |
| mpdu_ref_index[ tileID ][ patchIdx ] | ue(v) |
| OverridePlrFlag = 0 | |
| mpdu_override_2d_params_flag[ tileID ][ patchIdx ] | u(1) |
| if( mpdu_override_2d_params_flag[ tileID ][ patchIdx ] ) { | |
| mpdu_2d_pos_x[ tileID ][ patchIdx ] | se(v) |
| mpdu_2d_pos_y[ tileID ][ patchIdx ] | se(v) |
| mpdu_2d_delta_size_x[ tileID ][ patchIdx ] | se(v) |
| mpdu_2d_delta_size_y[ tileID ][ patchIdx ] | se(v) |
| mpdu_scale_depth_delta | se(v) |
| if( asps_plr_enabled_flag ) | |
| OverridePlrFlag = 1 | |
| } else { | |
| mpdu_override_3d_params_flag[ tileID ][ patchIdx ] | u(1) |
| if(mpdu_override_3d_params_flag[ tileID ][ patchIdx ] ) { | |
| mpdu_3d_offset_u[ tileID ][ patchIdx ] | se(v) |
| mpdu_3d_offset_v[ tileID ][ patchIdx ] | se(v) |
| mpdu_3d_offset_d[ tileID ][ patchIdx ] | se(v) |
| if( asps_normal_axis_max_delta_value_enabled_flag ) | |
| mpdu_3d_range_d[ tileID ][ patchIdx ] | se(v) |
| if( asps_plr_enabled_flag ) { | |
| mpdu_override_plr_flag[ tileID ][ patchIdx ] | u(1) |
| OverridePlrFlag = mpdu_override_plr_flag[ tileID ][ patchIdx ] | |
| } | |
| } | |
| } | |
| if( OverridePlrFlag && asps_plr_enabled_flag ) | |
| plr_data( tileID, patchIdx ) | |
| } | |

8.3.7.6 Inter patch data unit syntax

| | Descriptor |
|---|---|
| inter_patch_data_unit( tileID, patchIdx ) { | |
| if( NumRefIdxActive > 1 ) | |
| ipdu_ref_index[ tileID ][ patchIdx ] | ue(v) |
| ipdu_patch_index[ tileID ][ patchIdx ] | se(v) |
| ipdu_2d_pos_x[ tileID ][ patchIdx ] | se(v) |
| ipdu_2d_pos_y[ tileID ][ patchIdx ] | se(v) |
| ipdu_2d_delta_size_x[ tileID ][ patchIdx ] | se(v) |
| ipdu_2d_delta_size_y[ tileID ][ patchIdx ] | se(v) |
| ipdu_3d_offset_u[ tileID ][ patchIdx ] | se(v) |
| ipdu_3d_offset_v[ tileID ][ patchIdx ] | se(v) |
| ipdu_3d_offset_d[ tileID ][ patchIdx ] | se(v) |
| if( asps_normal_axis_max_delta_value_enabled_flag ) | |
| ipdu_3d_range_d[ tileID ][ patchIdx ] | se(v) |
| Ipdu_scale_depth_delta | se(v) |
| if( asps_plr_enabled_flag ) | |
| plr_data( tileID, patchIdx ) | |
| } | |

and the section 9.2.5.5.1 “General decoding process for patch data units coded in inter prediction mode” from wl9579_ISO_IEC_FDIS_23090-5 document, or respectively section 9.2.5.4 “Decoding process for patch data units coded in merge prediction mode” for the merge patch, must be updated to define the copy function as:

$$TilePatchScaleDepthValue [ tile ID ] [ p ] = ref PatchScaleDepthValue + Ipdu ScaleDepthDelta [ tile ID ] [ p ]$$

Respectively:

$$TilePatchScaleDepthValue [ tile ID ] [ p ] = ref PatchScaleDepthValue + mp du ScaleDepthDelta [ tile ID ] [ p ]$$

### Encoding Process

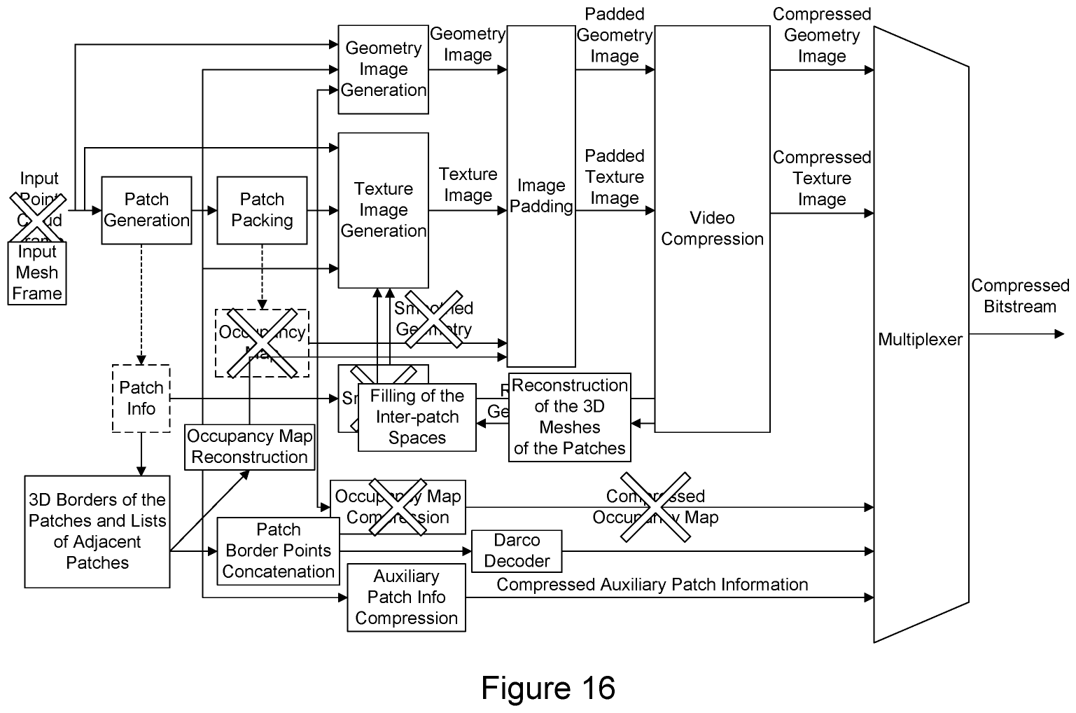

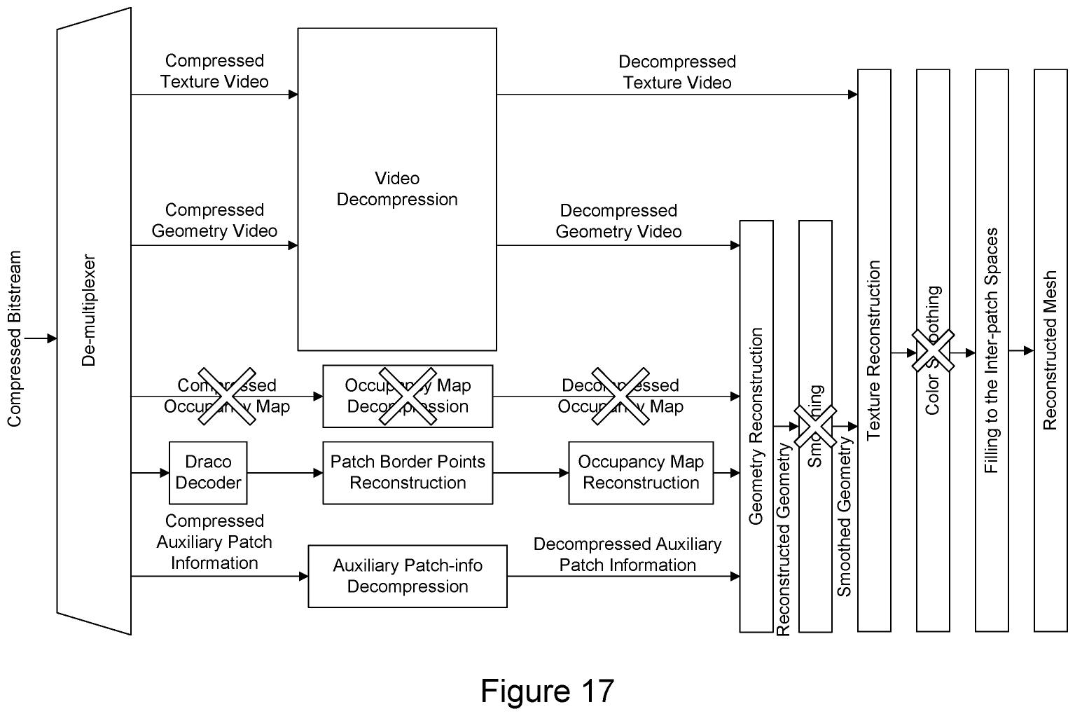

According to the previous descriptions, the encoding process is summarized below. The V-PCC encoding process has been updated to use the previously described process. FIG. 16 shows the modified architecture of the V-PCC encoder. This section will present more precisely the encoding process and in particular the new segmentation process that manages a mesh instead of a point cloud.

The segmentation process of the V-PCC encoder has been updated to consider the mesh format, and in particular to use the topology information of the surface given by this new format that was not available with the original point cloud format.

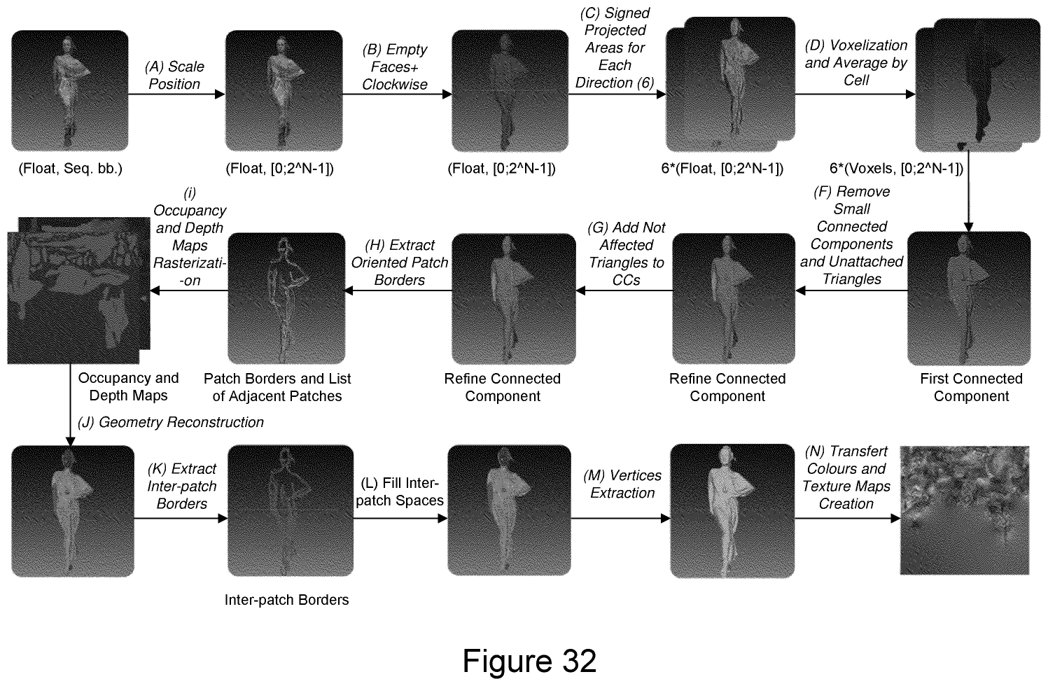

FIG. 32 shows the main stages of the encoding and segmentation processes that convert mesh models to patch information and 2D videos, which can be transmitted in the V-PCC bitstream. Each process present in the diagram in FIG. 32 will be described in more detail below.

### Scale Position

The Mesh V-PCC encoder loads as input a 3D mesh model. The input sequence's bounding box is scaled to the [0, 2^{N}−1] range, where N is the geometry quantization bit depth set by the user (FIG. 32a).

### Pre-Process

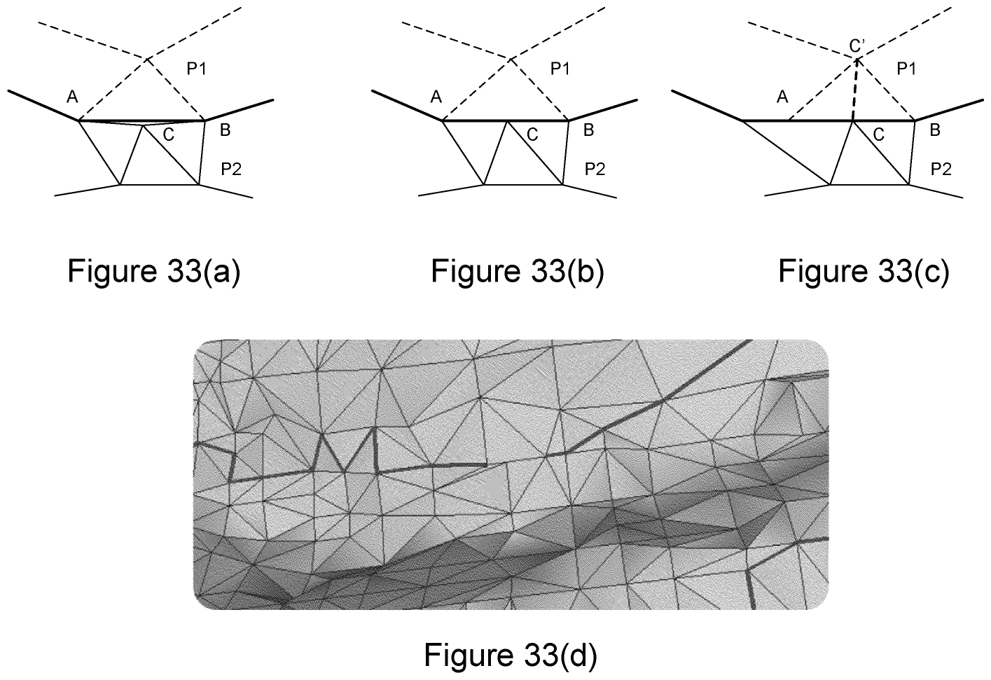

Before the encoding and segmentation processes, a pre-process (FIG. 32b) is executed on the source model to correct the geometry and topology of the mesh, to facilitate the following processes. Some triangles of the input model can be:
empty (no area: two of the three points are the same or the three points are aligned),
not well connected, as shown in the example in FIG. 33.d,
not correctly oriented with respect to adjacent triangles, due to quantization error some triangles orientation can be changed.

Some vertices defining the models, due to either the uv texture coordinates, the normal values, or to the color values, could be duplicated in the topology representation. To increase the efficiency of the following processes, all the duplicate vertices (in terms of position coordinates) are merged, to reduce the number of vertices that must be used.

As shown in FIG. 33, a mesh correction step is required to ensure that shared patch borders always contain identical segments on both sides. Indeed, by construction, or as a result of quantization, some faces may have a null area. If a degenerate triangle with 3 colinear vertices is removed, then the border will be constituted of two segments on one side and 1 on the other. The process detects the empty triangles (noted ABC on the FIG. 33), remove these triangles and correctly connect the vertex C, that are on an edge AB, to the adjacent triangle ABC′, by splitting this triangle by two new triangle ACC′ and CBC′.

The pre-process (FIG. 32.b) described above corrects the previously mentioned issues and we obtain a mesh with:
All triangles
   Not empty
   Connected to all their adjacent triangles (sharing a complete edge with their adjacent triangles)
   Correctly oriented
All vertices with the same position are unique (i.e., recorded only once)

### First Connected Component Creation

To create a set of 2D patches that could be well encoded in the V-PCC bitstreams, we need to group the triangles of the mesh into a set of connected components (CC, a group of connected triangles) that will be rasterized to create the 2D patches.

It is necessary for the created connected components to have specific properties, to guarantee that all the parts of the mesh model are well described in the patches and that the patches are not too complex to code. The properties are:
All the triangles of one CC must have a similar orientation according to the triangle normals.
All the triangles stored in one CC must have a maximum 2D projected area in the same projected 2D space (i.e., all the triangles are well described in the CC chosen projection plane).
The triangles of the connected components of various depth must not be rasterized into the same 2D position (i.e., the CC surface must not have folds and the projected areas of all triangles in the CC should be non-overlapping).
The depth range of the triangles projected according to the patch projection parameter must be in the range [0, N−1], where N is the bit depth of the geometry video.
The CC should be as large as possible to limit the number of CCs used to describe the mesh, and therefore to guarantee a good compression efficiency.

To group the triangles, we describe each triangle by a vector S of size numberOfProjection, where numberOfProjection is the number of projection planes used to describe the mesh (6 projection planes by default: {−X, +X, −Y, +Y, −Z, +Z}, or more if 45° projections or extended projection plane modes are used. These modes could be activated with the flag: ptc_45 degree_no_projection_patch_constraint_flag and asps_extended_projection_enabled_flag.) (FIG. 32c).

For each triangle j and for each projection plane i in [0, numberOfProjection −1], we store in S the normalized signed area of the 2D triangle projected onto the corresponding plane i:

$$S ( i , j ) = {Normal}_{i} \cdot {Normal}_{j} * \frac{area 2 D ( {Triangle}_{j} \cdot {Proj Plane}_{i} )}{area 3 D ( {Triangle}_{j} )}$$

where i is the projection plane index and j is the index of the triangles. The sign of the 2D area is set by comparing the projection plane orientation and the 3D triangle orientation. This can be computed with the dot product between the normal of the current 3D triangle, Normalⱼ, and the normal of the used projection plane, Normalᵢ.

Each triangle is represented by a vector S that describes the capability of the triangle to be represented by the projection planes.

To limit the number of created CCs, S vectors of each triangle are averaged according to the neighborhood triangles (FIG. 32d). For this, a 3D grid of size [0, 2^{N-V}−1]³ is used where N is the geometry bit depth and V is the squared size of the cells (input parameter: voxelDimensionRefineSegmentation).

For each 3D cell, we compute the average of S of all the triangles intercepting the cell, noted cellS. The values of cellS are averaged according to the neighborhood cells (all cells at a distance inferior to an input parameter: searchSizeRefineSegmentation). For all triangles in the cell, we update S with cellS. This process could be executed several times according to the input parameter: iterationCountRefineSegmentation.

For each orientation i, we set the score of the orientation i equal to the normalized score of one virtual triangle parallel to the corresponding projection plane. These scores are noted ScoreProjPlane(i).

According to the average scores S, we can group to each CC of index I, each triangle j that has:
A minimum distance between ScoreProjPlane(i) and S(j), and;
Can be rasterized:
With all the depth values in the range [0, 2^{N}−1], and;
Without values of depth that are too large (i.e., must have absolute depth distance inferior to a threshold) from the already projected triangles' depth values in the neighboring area (all positions at distance inferior to the threshold: maxDepthVariationInNeighborhood).

During this process, if too small a CC is found (number of triangles inferior to minNumberOfTriangleByCC), the triangles of this CC are unregistered and allowed to be attached to other CCs.

This process creates the first connected component segmentation (FIG. 32e), which will be refined in the following process.

### Connected Component Refinement

To refine the CC, based on the first CC segmentation, the isolated triangles (not attached by an edge to the current CC) or the triangles that are not attached to any CC are evaluated to see if they can be added to an existing CC.

Each isolated triangle that is not attached to any other triangle of the CC by an edge (two adjacent triangles must share two vertices) is removed from the CC (FIG. 32f).

For each triangle that is not represented in a CC, we check for each neighboring CC if the triangle can be rasterized, and out of all the possible CCs we attach the triangle to the largest one (FIG. 32g).

Note: the connected components CC are now named a “patch” in the following section

### Border Patch Segments Extraction

The patch border segments of the patches are extracted as described in Section 6.1 (FIG. 32h).

### Occupancy and Depth Maps Rasterization

The occupancy maps of the patches can be created from the patch border segments as described in Section 6.3 (FIG. 32i).

Using the 3D triangles and the occupancy map of each patch, we can rasterize the triangles of the patch in all the areas defined by the occupancy map and store these values in the depth map of the patch.

According to the process defined in an earlier section, the depth values of the patch can be scaled or not.

### Geometry Reconstruction

The 3D meshes of the patches can be reconstructed from depth maps and from the occupancy maps as described in Section 6.4 (FIG. 32.j).

### Fill Inter-Patch Spaces

The inter-patch spaces can be filled according to the border patch segments and to the border edges of the reconstructed meshes of the patches, as described in Section 6.5 (FIG. 32.k and .l).

### Attribute Frame Creation

Based on the reconstructed meshes (patch+inter-patch filling), we can extract all the vertices of the mesh to create a reconstructed point cloud (FIG. 32.m), noted RecPC.

This reconstructed point cloud has no colors, and we need to color the points. Based on the source mesh model, we can create a dense, colored source point cloud by sampling and quantizing the source mesh. This process creates a source-colored point cloud, noted SourcePC.

Like in V3CN-PCC point cloud encoding, we can use a color transfer process, which colors the reconstructed point cloud based on the source point cloud colors. The colors of the RecPC points are obtained from the closest corresponding points in the SourcePC.

Each point of the point cloud has (u,v) frame coordinates, which define the coordinates of the pixels in the depth map and in the attribute map that will be used to set the pixel values of the attribute frame of each reconstructed colored point (FIG. 32.n).

### Decoding Process

According to the previous description, the decoding process is summarized below.

The V3CN-PCC bitstream is parsed to get the stored data:
Patch metadata, containing:
   Patch parameters
   List of adjacent patches
Compressed lists of border points bitstreams
Geometry video bitstreams
Attribute video bitstreams

The video bitstreams are decoded to obtain the depth maps and the attribute maps.

The bitstreams containing the lists of border points are decoded to obtain the segments of border points.

The lists of the adjacent patches are rebuilt patch by patch based on the pdu_delta_adjacent_patches, mpdu_delta_adjacent_patches and ipdu_delta_adjacent_patches information.

The lists of the adjacent patches are used to rebuild the segments of border points of patches.

The segments of border points of patches are used to build the occupancy maps of the patches.

Based on the occupancy, depth and attribute maps, the meshes of the patches are built.

The filling of the inter-patch spaces is executed between the reconstructed patches and the segments of the border points to obtain the reconstructed models.

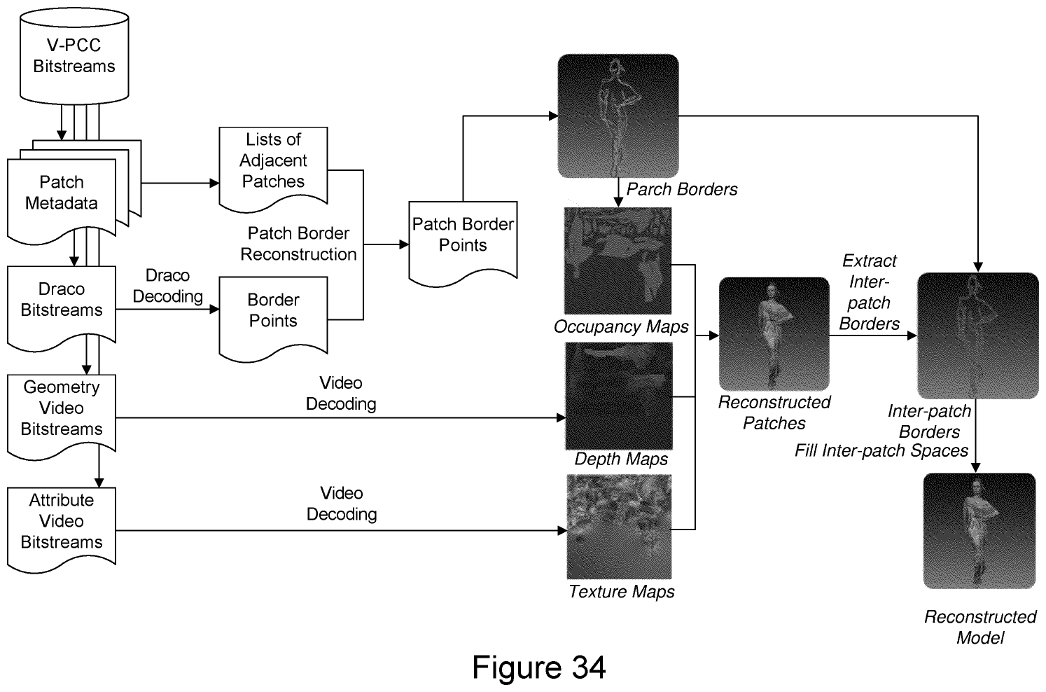

FIG. 34 shows these processes.

The general aspects described herein have direct application to the V-MESH coding draft. CfP issued in October 2021. These aspects have potential to be adopted in the V-MESH standard as part of the specification.

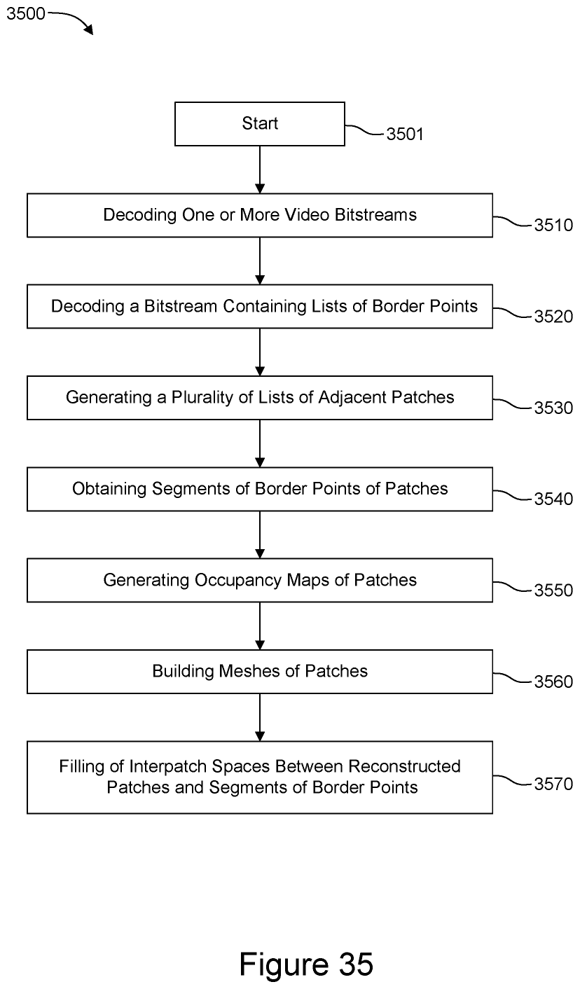

One embodiment of a method 3500 under the general aspects described here is shown in FIG. 35. The method commences at start block 3501 and control proceeds to block 3510 for decoding one or more video bitstreams to obtain depth maps and attribute maps. Control proceeds from block 3510 to block 3520 for further decoding a bitstream containing lists of border points to obtain segments of border points. Control proceeds from block 3520 to block 3530 for generating a plurality of lists of adjacent patches based on syntax information.

Control proceeds from block 3530 to block 3540 for obtaining segments of border points of patches from said border points coded in said bitstream and from said lists of adjacent patches;

Control proceeds from block 3540 to block 3550 for generating occupancy maps of said patches using segments of border points of patches;

Control proceeds from block 3550 to block 3560 for building meshes of said patches based on occupancy, depth, and attribute maps; and,

Control proceeds from block 3560 to block 3570 for filling of inter-patch spaces between reconstructed patches and said segments of border points to obtain reconstructed models

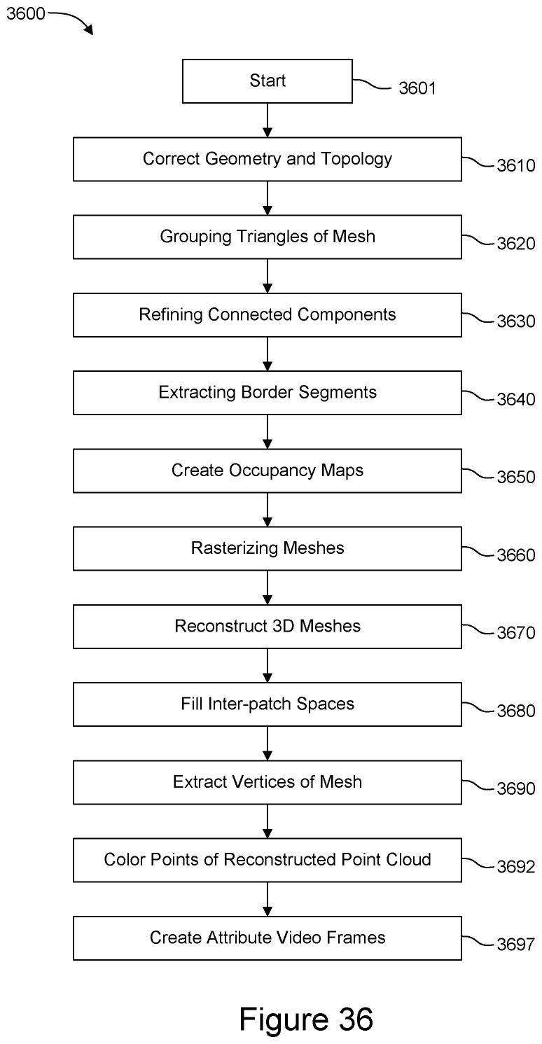

Another embodiment of a method 3600 under the general aspects described here is shown in FIG. 36. The method commences at start block 3601 and control proceeds to block 3610 for correcting geometry and topology of a scaled three-dimensional mesh model.

Control proceeds from block 3610 to block 3620 for grouping triangles of the mesh into connected components. Control proceeds from block 3620 to block 3630 for refining said connected components. Control proceeds from block 3630 to block 3640 for extracting patch border segments of patches. Control proceeds from block 3640 to block 3650 for creating occupancy maps of said patches from said patch border segments.

Control proceeds from block 3650 to block 3660 for rasterizing meshes of the connected component of said patches to create depth maps of the patches and depth video frames. Control proceeds from block 3660 to block 3670 for reconstructing three-dimensional meshes of said patches from depth maps and said occupancy maps.

Control proceeds from block 3670 to block 3680 for filling inter-patch spaces based on said patch border segments and border edges of the reconstructed meshes of the patches.

Control proceeds from block 3680 to block 3690 for extracting all vertices of the mesh based on said reconstructed meshes to create a reconstructed point cloud. Control proceeds from block 3690 to block 3692 for coloring the points of the reconstructed point cloud. Control proceeds from block 3692 to block 3697 for using the colored reconstructed point cloud to create attribute video frames.

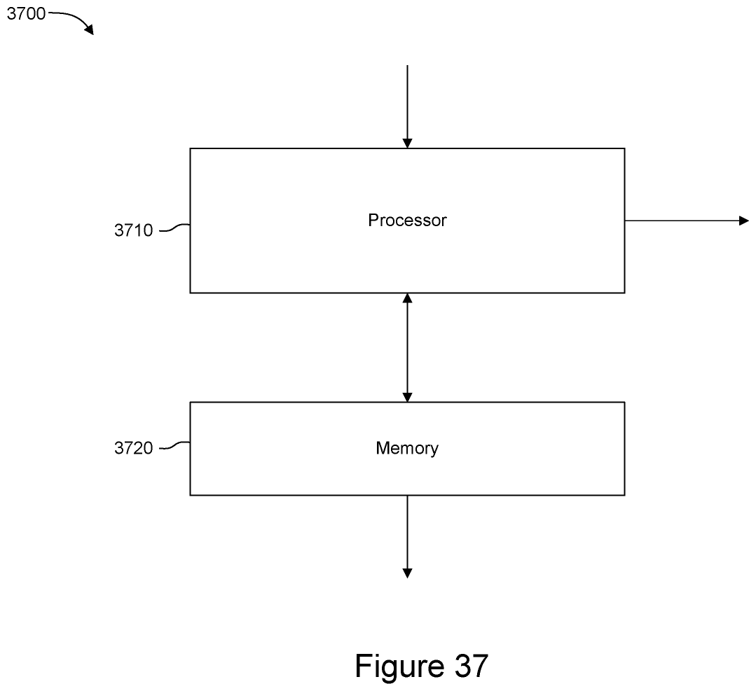

FIG. 37 shows one embodiment of an apparatus 3700 for segmentation, compression, analysis, interpolation, representation and understanding of point cloud signals. The apparatus comprises Processor 3710 and can be interconnected to a memory 3720 through at least one port. Both Processor 3710 and memory 3720 can also have one or more additional interconnections to external connections.

Processor 3710 is also configured to either insert or receive information in a bitstream and, performing either segmentation, compression, analysis, interpolation, representation and understanding of point cloud signals using any of the described aspects.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The aspects described and contemplated in this application can be implemented in many different forms. FIGS. 35, 36 and 37 provide some embodiments, but other embodiments are contemplated and the discussion of FIGS. 35, 36 and 37 does not limit the breadth of the implementations. At least one of the aspects generally relates to segmentation, compression, analysis, interpolation, representation and understanding of point cloud signals. These and other aspects can be implemented as a method, an apparatus, a computer readable storage medium having stored thereon instructions for segmentation, compression, analysis, interpolation, representation and understanding of point cloud signals according to any of the methods described, and/or a computer readable storage medium having stored thereon a bitstream generated according to any of the methods described.

Various methods are described herein, and each of the methods comprises one or more steps or actions for achieving the described method. Unless a specific order of steps or actions is required for proper operation of the method, the order and/or use of specific steps and/or actions may be modified or combined.

Various numeric values are used in the present application. The specific values are for example purposes and the aspects described are not limited to these specific values.

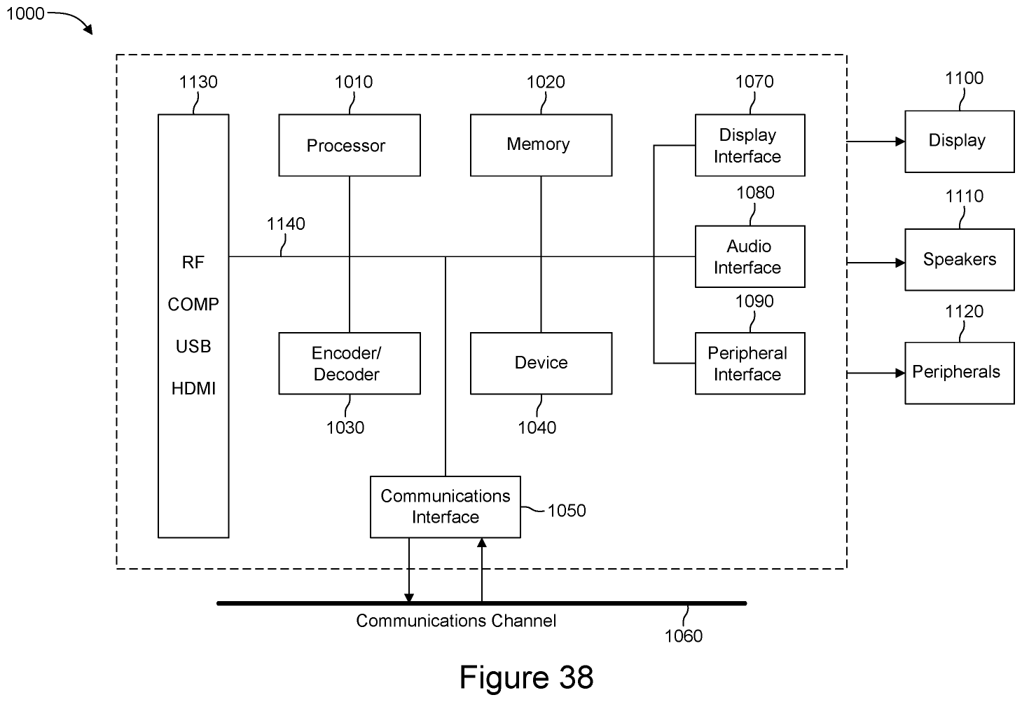

FIG. 38 illustrates a block diagram of an example of a system in which various aspects and embodiments are implemented. System 3800 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 3710 configured to execute instructions loaded therein for implementing, for example, the various aspects described in this document. Processor 3710 can include embedded memory, input output interface, and various other circuitries as known in the art. The system 3700 includes at least one memory 3720 (e.g., a volatile memory device, and/or a non-volatile memory device).

System 3700 can include a storage device, which can include non-volatile memory and/or volatile memory, including, but not limited to, Electrically Erasable Programmable Read-Only Memory (EEPROM), Read-Only Memory (ROM), programmable Read-Only Memory (PROM), Random Access Memory (RAM), Dynamic Random Access Memory (DRAM), Static Random Access Memory (SRAM), flash, magnetic disk drive, and/or optical disk drive. The storage device can include an internal storage device, an attached storage device (including detachable and non-detachable storage devices), and/or a network accessible storage device, as non-limiting examples.

Program code to be loaded onto processor 3710 to perform the various aspects described in this document can be stored in a storage device and subsequently loaded onto memory 3720 for execution by processor 3710. In accordance with various embodiments, one or more of processor 3710, memory 3720, or a storage device can store one or more of various items during the performance of the processes described in this document.

In some embodiments, memory inside of the processor 3710 and/or the memory 3720 is used to store instructions and to provide working memory for processing that is needed. In other embodiments, however, a memory external to the processing device (for example, the processing device can be either the processor 3710 or an external device) is used for one or more of these functions. The external memory can be the memory 3720 and/or a storage device, for example, a dynamic volatile memory and/or a non-volatile flash memory. In several embodiments, an external non-volatile flash memory is used to store the operating system of, for example, a television.

The embodiments can be carried out by computer software implemented by the processor 3710 or by hardware, or by a combination of hardware and software. As a non-limiting example, the embodiments can be implemented by one or more integrated circuits. The memory 3720 can be of any type appropriate to the technical environment and can be implemented using any appropriate data storage technology, such as optical memory devices, magnetic memory devices, semiconductor-based memory devices, fixed memory, and removable memory, as non-limiting examples. The processor 3710 can be of any type appropriate to the technical environment, and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments, across various claim categories and types. Features of these embodiments can be provided alone or in any combination. Further, embodiments can include one or more of the following features, devices, or aspects, alone or in any combination, across various claim categories and types:
Transmitting 3-Dimensional borders of patches (list of the 3D points constituting the borders of the patches)
Using the border information to identify which parts of the 2D patches are occupied
Connecting the 3D reconstructed patches according to the real 3D borders of the patches
Creating and/or transmitting and/or receiving and/or decoding a bitstream or signal that includes one or more of the described syntax elements, or variations thereof.
A TV, set-top box, cell phone, tablet, or other electronic device that performs transform method(s) according to any of the embodiments described.
A TV, set-top box, cell phone, tablet, or other electronic device that performs transform method(s) determination according to any of the embodiments described, and that displays (e.g. using a monitor, screen, or other type of display) a resulting image.
A TV, set-top box, cell phone, tablet, or other electronic device that selects, bandlimits, or tunes (e.g. using a tuner) a channel to receive a signal including an encoded image, and performs transform method(s) according to any of the embodiments described.
A TV, set-top box, cell phone, tablet, or other electronic device that receives (e.g. using an antenna) a signal over the air that includes an encoded image, and performs transform method(s).

1. A method for decoding mesh models, comprising:
decoding one or more video bitstreams to obtain depth maps and attribute maps;
further decoding a bitstream containing lists of border points to obtain segments of border points;
generating a plurality of lists of adjacent patches based on syntax information;
obtaining segments of border points of patches from said border points coded in said bitstream and from said lists of adjacent patches;
generating occupancy maps of said patches using segments of border points of patches;
building meshes of said patches based on occupancy, depth, and attribute maps; and,
filling of inter-patch spaces between reconstructed patches and said segments of border points to obtain reconstructed models.

2. An apparatus for decoding mesh models, comprising a memory and a processor configured to perform:
decoding one or more video bitstreams to obtain depth maps and attribute maps;
further decoding a bitstream containing lists of border points to obtain segments of border points;
generating a plurality of lists of adjacent patches based on syntax information;
obtaining segments of border points of patches from said border points coded in said bitstream and from said lists of adjacent patches;
generating occupancy maps of said patches using segments of border points of patches;
building meshes of said patches based on occupancy, depth, and attribute maps; and,
filling of inter-patch spaces between reconstructed patches and said segments of border points to obtain reconstructed models.

3. A method for encoding a mesh model, comprising:
correcting geometry and topology of a scaled three-dimensional mesh model;
grouping triangles of the mesh into connected components;
refining said connected components;
extracting patch border segments of patches;
creating occupancy maps of said patches from said patch border segments;
rasterizing meshes of the connected component of said patches to create depth maps of the patches and depth video frames;
reconstructing three-dimensional meshes of said patches from depth maps and said occupancy maps;
filling inter-patch spaces based on said patch border segments and border edges of the reconstructed meshes of the patches;
extracting all vertices of the mesh based on said reconstructed meshes to create a reconstructed point cloud;
coloring the points of the reconstructed point cloud; and,
using the colored reconstructed point cloud to create attribute video frames.

4. An apparatus for encoding a mesh model, comprising a memory and a processor configured to perform:
correcting geometry and topology of a scaled three-dimensional mesh model;
grouping triangles of the mesh into connected components;
refining said connected components;
extracting patch border segments of patches;
creating occupancy maps of said patches from said patch border segments;
rasterizing meshes of the connected component of said patches to create depth maps of the patches and depth video frames;
reconstructing three-dimensional meshes of said patches from depth maps and said occupancy maps;
filling inter-patch spaces based on said patch border segments and border edges of the reconstructed meshes of the patches;
extracting all vertices of the mesh based on said reconstructed meshes to create a reconstructed point cloud;
coloring the points of the reconstructed point cloud; and,
using the colored reconstructed point cloud to create attribute video frames.

5. The method of claim 1, wherein said generating occupancy maps comprises:
computing intersection points with border segments of said patches; and,
indicating intersection points that are within said patches.

6. The method of claim 1, wherein said
building meshes of said patches and filling of inter-patch spaces comprises:
reconstructing occupied pixels of said maps in parallel; and,
directly filling inter-patch spaces.

7. The apparatus of claim 2, wherein said generating occupancy maps comprises:
computing intersection points with border segments of said patches; and,
indicating intersection points that are within said patches.

8. The apparatus of claim 2, wherein said
building meshes of said patches and filling of inter-patch spaces comprises:
reconstructing occupied pixels of said maps in parallel; and, directly filling inter-patch spaces.

9. The method of claim 3, wherein said generating occupancy maps comprises:
computing intersection points with border segments of said patches; and,
indicating intersection points that are within said patches.

10. The method of claim 3, wherein said
building meshes of said patches and filling of inter-patch spaces comprises:
reconstructing occupied pixels of said maps in parallel; and,
directly filling inter-patch spaces.

11. The apparatus of claim 4, wherein said generating occupancy maps comprises:
computing intersection points with border segments of said patches; and,
indicating intersection points that are within said patches.

12. The apparatus of claim 4, wherein said
building meshes of said patches and filling of inter-patch spaces comprises:
reconstructing occupied pixels of said maps in parallel; and,
directly filling inter-patch spaces.
